(19) United States
(12) Patent Application Publication
(10) Pub. No.: US 2024/0152845 A1
(43) Pub. Date: May 9, 2024

(54) TECHNIQUES FOR MEASURING ORGANIZATIONAL PRODUCTIVITY

(71) Applicant: Okta, Inc., San Francisco, CA (US)

(72) Inventors: Fei Liu, Cupertino, CA (US); Todd Roland McKinnon, San Francisco, CA (US)

(21) Appl. No.: 18/051,186

(22) Filed: Oct. 31, 2022

(51) Int. Cl. G06Q 10/0639

(52) U.S. Cl. CPC G06Q 10/06393

(57) ABSTRACT

Methods, systems, and devices for measuring organizational productivity are described. A software platform of a device may obtain performance information associated with an organization from a plurality of sources. The software platform may output analytics corresponding to a performance of the organization based on the performance information and one or more rules. The one or more rules may be based on a relationship between a rate of outcomes, an output-outcome efficiency, an organizational potential, and an organizational resistance.

### FIELD OF TECHNOLOGY

The present disclosure relates generally to database systems and data processing, and more specifically to techniques for measuring organizational productivity.

### BACKGROUND

A software platform may serve multiple different tenants (e.g., organizations, customers) that may share a same software application, a same underlying architecture, same resources (e.g., compute resources, memory resources), a same database, same servers, or cloud-based resources, or any combination thereof. In some examples, an organizational productivity associated with a tenant (e.g., organization) served by the software platform may correspond to a rate at which the organization may utilize resources to achieve outcomes. In some examples, organizations may implement one or more techniques to manage organizational productivity. For example, some organizations may utilize techniques based on management science, behavioral and psychological theories regarding employee motivation, and organizational designs for managing organizational productivity. In some cases, however, existing techniques for managing organizational productivity may be deficient or sub-optimal in some current configurations.

### SUMMARY

The present disclosure relates to improved devices and apparatuses that support techniques for measuring organizational productivity. For example, the present disclosure provides a framework for modeling organizational productivity using Organizational Ohm's Law. In some examples, a software platform of a device may obtain performance information associated with an organization from a plurality of sources. In such examples, the software platform may output analytics corresponding to a performance of the organization based on the performance information and one or more rules. The one or more rules may be based on a relationship between a rate of outcomes, an output-outcome efficiency, an organizational potential, and an organizational resistance. For example, the one or more rules may be based on Organizational Ohm's Law.

A method for managing organizational performance at a device is described. The method may include obtaining, at a software platform of the device, performance information associated with an organization from a set of multiple sources and outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

An apparatus for managing organizational performance at a device is described. The apparatus may include a processor, memory coupled with the processor, and instructions stored in the memory. The instructions may be executable by the processor to cause the apparatus to obtain, at a software platform of the device, performance information associated with an organization from a set of multiple sources and outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

Another apparatus for managing organizational performance at a device is described. The apparatus may include means for obtaining, at a software platform of the device, performance information associated with an organization from a set of multiple sources and means for outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

A non-transitory computer-readable medium storing code for managing organizational performance at a device is described. The code may include instructions executable by a processor to obtain, at a software platform of the device, performance information associated with an organization from a set of multiple sources and outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

In some examples of the method, apparatuses, and non-transitory computer-readable medium described herein, obtaining the performance information may include operations, features, means, or instructions for obtaining objective data associated with the organization from a first source of the set of multiple sources and subjective data associated with the organization from a second source of the set of multiple sources, where the performance information includes the objective data and the subjective data.

In some examples of the method, apparatuses, and non-transitory computer-readable medium described herein, the first source includes a system log of one or more software-as-a-service products associated with the organization and the second source includes a survey conducted at the organization.

In some examples of the method, apparatuses, and non-transitory computer-readable medium described herein, obtaining the performance information may include operations, features, means, or instructions for obtaining the performance information associated with an organization from internal operation data associated with the organization, customer data associated with the organization, third-party data associated with the organization, or data obtained from a survey conducted at the organization, or any combination thereof.

In some examples of the method, apparatuses, and non-transitory computer-readable medium described herein, outputting the analytics may include operations, features, means, or instructions for outputting an organizational output current metric based on organizational objective information and the one or more rules, where the performance information includes the organizational objective information, and where the analytics include the organizational output current metric.

In some examples of the method, apparatuses, and non-transitory computer-readable medium described herein, the organizational objective information corresponds to sales revenue, profit revenue, revenue growth rate, profit margin, and environmental, social, and corporate governance, or any combination thereof.

In some examples of the method, apparatuses, and non-transitory computer-readable medium described herein, outputting the analytics may include operations, features, means, or instructions for outputting an organizational outcome efficiency metric based on organizational outcome information and the one or more rules, where the performance information includes the organizational outcome information, and where the analytics include the organizational outcome efficiency metric.

In some examples of the method, apparatuses, and non-transitory computer-readable medium described herein, the organizational outcome information corresponds to a respective customer satisfaction score associated with each feature of a set of multiple features developed at the organization.

In some examples of the method, apparatuses, and non-transitory computer-readable medium described herein, outputting the analytics may include operations, features, means, or instructions for outputting a set of multiple organizational resistance metrics based on organizational resistance information and the one or more rules, where the performance information includes the organizational resistance information, and where the analytics include the set of multiple organizational resistance metrics.

In some examples of the method, apparatuses, and non-transitory computer-readable medium described herein, the organizational resistance information corresponds to a distribution of a set of multiple durations during which one or more employees of the organization perform a set of multiple tasks and each duration of the set of multiple durations corresponds to a respective task of the set of multiple tasks.

Some examples of the method, apparatuses, and non-transitory computer-readable medium described herein may further include operations, features, means, or instructions for outputting a model of a circuit representative of a structure of the organization, where the circuit includes a set of multiple resistors, and where each resistor of the set of multiple resistors corresponds to a respective organizational resistance metric of the set of multiple organizational resistance metrics.

Some examples of the method, apparatuses, and non-transitory computer-readable medium described herein may further include operations, features, means, or instructions for outputting a first value of an organizational performance metric based on the circuit, obtaining an adjustment associated with the structure of the organization based on the first value of the organizational performance metric, and obtaining a second value of the organizational performance metric based on the adjustment, the second value may be different from the first value.

In some examples of the method, apparatuses, and non-transitory computer-readable medium described herein, the organizational performance metric includes an organizational productivity metric or an organizational efficiency metric.

In some examples of the method, apparatuses, and non-transitory computer-readable medium described herein, outputting the analytics may include operations, features, means, or instructions for outputting an organizational potential metric based on organizational potential information and the one or more rules, where the performance information includes the organizational potential information, and where the analytics include the organizational potential metric.

In some examples of the method, apparatuses, and non-transitory computer-readable medium described herein, the organizational potential information corresponds to a respective skill and a respective motivation associated with each employee of one or more employees of the organization.

In some examples of the method, apparatuses, and non-transitory computer-readable medium described herein, the performance information includes historical information collected over a duration and the analytics may be based on the historical information.

Some examples of the method, apparatuses, and non-transitory computer-readable medium described herein may further include operations, features, means, or instructions for outputting a set of analytics corresponding to the performance of the organization, where the set of analytics may be associated with a set of multiple features provided by a software application associated with the organization, and where the performance information includes respective performance information associated with each feature of the set of multiple features.

Some examples of the method, apparatuses, and non-transitory computer-readable medium described herein may further include operations, features, means, or instructions for selecting a feature of the set of multiple features based on the set of analytics.

### BRIEF DESCRIPTION OF THE DRAWINGS

FIG. 1 illustrates an example of a managing organizational performance system that supports techniques for measuring organizational productivity in accordance with aspects of the present disclosure.

FIG. 2 illustrates an example of a model circuit that supports techniques for measuring organizational productivity in accordance with aspects of the present disclosure.

FIG. 3 illustrates an example of a communication pathway that supports techniques for measuring organizational productivity in accordance with aspects of the present disclosure.

FIG. 4 illustrates an example of a model circuit that supports techniques for measuring organizational productivity in accordance with aspects of the present disclosure.

FIGS. 5A and 5B illustrate examples of a model circuit that supports techniques for measuring organizational productivity in accordance with aspects of the present disclosure.

FIG. 6 illustrates an example of an engineering team diagram that supports techniques for measuring organizational productivity in accordance with aspects of the present disclosure.

FIG. 7 illustrates an example of a model circuit that supports techniques for measuring organizational productivity in accordance with aspects of the present disclosure.

FIG. 8 illustrates an example of a process flow that supports techniques for measuring organizational productivity in accordance with aspects of the present disclosure.

FIG. 9 illustrates a block diagram of an apparatus that supports techniques for measuring organizational productivity in accordance with aspects of the present disclosure.

FIG. 10 illustrates a block diagram of a software platform that supports techniques for measuring organizational productivity in accordance with aspects of the present disclosure.

FIG. 11 illustrates a diagram of a system including a device that supports techniques for measuring organizational productivity in accordance with aspects of the present disclosure.

FIGS. 12 and 13 illustrate flowcharts showing methods that support techniques for measuring organizational productivity in accordance with aspects of the present disclosure.

### DETAILED DESCRIPTION

In some examples, organizational productivity may correspond to a rate at which an organization may utilize resources to achieve one or more outcomes and an ability of the organization to deliver an outcome may provide one or more advantages for the organization. In such examples, the organization may implement one or more techniques to manage (e.g., and improve) organizational productivity. In some examples, such techniques may be based on management science and include a goal-setting methodology, which may include using objectives and key results (OKRs) to set goals, create alignment, and track measurable results. Additionally, or alternatively, such techniques may be based on behavioral and psychological theories regarding employee motivation. In some examples, the organization may utilize techniques based on one or more motivational theories to manage organizational productivity associated with day-to-day operations. Additionally, or alternatively, the organization may use techniques that include one or more organizational designs to manage organizational productivity. In some examples, however, some techniques for managing organizational productivity may fail to accurately capture an interdependency between organizational productivity, organizational potential, and organizational resistance, which may lead to an inaccurate understanding of organizational productivity within the organization. Moreover, such techniques may lack a mechanism for quantifying organizational productivity, which may lead to unnecessary underachievement.

Various aspects of the present disclosure generally relate to techniques for measuring organizational productivity, and more specifically, to a framework for modeling organizational productivity using Organizational Ohm's Law. In some examples, a software platform of a device may use Organizational Ohm's Law as a tool for modeling the organizational productivity associated with an organization retrospectively and predictively. For example, organizational productivity may correspond to organizational velocity (e.g., the rate at which an organization may utilize resources to achieve one or more outcomes). Additionally, Organizational Ohm's Law may be used to model organizational velocity as current. For example, Organizational Ohm's Law may indicate that outcome current (e.g., organizational velocity) is proportional to outcome-output efficiency and organizational potential, and inversely proportional to organizational resistance. As such, Organizational Ohm's Law may provide a framework for modeling (e.g., understanding) organizational productivity, and more specifically, organizational velocity retrospectively and predictively. That is, Ohm's Law may be applied to organizations to obtain an organizational productivity associated with the organization, which may be based on an interaction between an outcome-output efficiency, an organizational potential, and an organizational resistance associated with the organization.

In some examples, an organization may use a software platform to determine (e.g., and manage) an organizational productivity associated with the organization. For example, a software platform may serve multiple different organizations (e.g., tenants, customers) that may share a same software application (e.g., software as a service (SaaS) applications), a same underlying architecture, same resources (e.g., compute resources, memory resources), a same database, same servers, or cloud-based resources, or any combination thereof. In such an example, the software platform may be configured to obtain performance information associated with an organization (e.g., each organization served by the software platform) from a set of multiple of sources. Additionally, the software platform may output analytics corresponding to a performance of the organization based on the performance information and one or more rules. In some examples, the one or more rules may be based on a relationship between a rate of outcomes, an output-outcome efficiency, an organizational potential, and an organizational resistance. That is, the one or more rules may be based on Organizational Ohm's Law.

In some examples, the performance information may include objective data associated with the organization and subjective data associated with the organization. For example, the software platform may obtain objective data from a system log (syslog) of one or more SaaS applications associated with (e.g., used by or built by) the organization and subjective data from a survey conducted at the organization. In such an example, the set of multiple sources may include the syslog of the one or more SaaS applications and the survey conducted at the organization. For example, the set of multiple sources may include internal operation data associated with the organization, customer data associated with the organization (e.g., including the syslog of the one or more SaaS applications), third-party (e.g., software) data associated with the organization, or data obtained from the survey conducted at the organization, or any combination thereof. In some examples, using (e.g., analyzing) the set of multiple sources (e.g., heterogeneous sources of data) to output the analytics corresponding to the performance of the organization may lead to increased understanding (e.g., insight) of organizational productivity associated with the organization, among other possible benefits.

Aspects of the disclosure are initially described in the context of a system for distributed computing (e.g., cloud computing). Aspects of the disclosure are also described in the context of model circuits, a communication pathway, and an engineering team diagram. Aspects of the disclosure are further illustrated by and described with reference to apparatus diagrams, system diagrams, and flowcharts that relate to techniques for measuring organizational productivity.

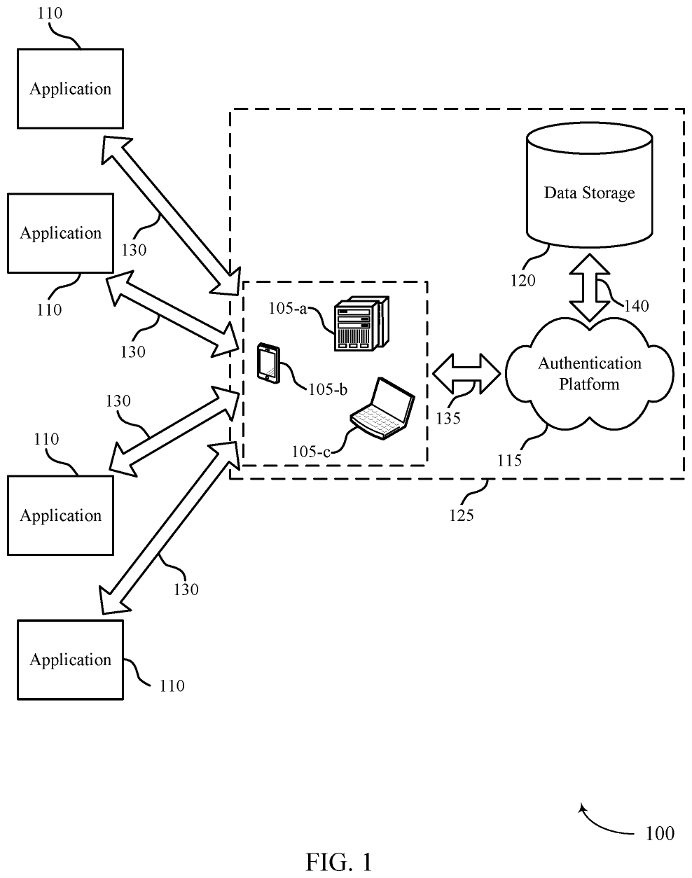

FIG. 1 illustrates an example of a system 100 for distributed computing (e.g., cloud computing) that supports techniques for measuring organizational productivity in accordance with various aspects of the present disclosure. The system 100 includes client devices 105, applications 110, authentication platform 115, and data storage 120. Authentication platform 115 may be an example of a public or private cloud network. A client device 105 may access authentication platform 115 over network connection 135. The network may implement transmission control protocol and internet protocol (TCP/IP), such as the Internet, or may implement other network protocols. A client device 105 may be an example of a user device, such as a server (e.g., client device 105 a), a smartphone (e.g., client device 105 b), or a laptop (e.g., client device 105 c). In other examples, a client device 105 may be a desktop computer, a tablet, or another computing device or system capable of generating, analyzing, transmitting, or receiving communications. In some examples, a client device 105 may be operated by a user that is part of a business, an enterprise, a non-profit, a startup, or any other organization type.

A client device 105 may interact with multiple applications 110 via one or more interactions 130. The interactions 130 may include digital communications, application programming interface (API) calls, hypertext transfer protocol (HTTP) messages, or any other interaction between a client device 105 and an application 110. Data may be associated with the interactions 130. A client device 105 may access authentication platform 115 to store, manage, and process the data associated with the interactions 130. In some examples, the client device 105 may have an associated security or permission level. A client device 105 may have access to some applications, data, and database information within authentication platform 115 based on the associated security or permission level, and may not have access to others.

Applications 110 may interact with the client device 105 via email, web, text messages, or any other suitable form of interaction. The interaction 130 may be a business-to-business (B2B) interaction or a business-to-consumer (B2C) interaction. An application 110 may also be referred to as a customer, a client, a website, or some other suitable terminology. In some examples, the application 110 may be an example of a server, a node, a compute cluster, or any other type of computing system, component, or environment. In some examples, the application 110 may be operated by a user or group of users.

Authentication platform 115 may offer cloud-based services to the client devices 105, the applications 110, or both. In some examples, authentication platform 115 may support a database system such as a multi-tenant database system. In such cases, authentication platform 115 may serve multiple client devices 105 with a single instance of software. However, other types of systems may be implemented, including—but not limited to—client-server systems, mobile device systems, and mobile network systems. Authentication platform 115 may receive data associated with interactions 130 from the client device 105 over network connection 135, and may store and analyze the data. In some examples, authentication platform 115 may receive data directly from an interaction 130 between an application 110 and the client device 105. In some examples, the client device 105 may develop applications to run on authentication platform 115. Authentication platform 115 may be implemented using remote servers. In some examples, the remote servers may be examples of data storage 120.

Data storage 120 may include multiple servers. The multiple servers may be used for data storage, management, and processing. Data storage 120 may receive data from authentication platform 115 via connection 140, or directly from the client device 105 or an interaction 130 between an application 110 and the client device 105. Data storage 120 may utilize multiple redundancies for security purposes. In some examples, the data stored at data storage 120 may be backed up by copies of the data at multiple locations.

Subsystem 125 may include client devices 105, authentication platform 115, and data storage 120. In some examples, data processing may occur at any of the components of subsystem 125, or at a combination of these components. In some examples, servers may perform the data processing. The servers may be a client device 105 or located at data storage 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using APIs) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, a tenant (e.g., organization) served by the subsystem 125 (e.g., a software platform) may use one or more techniques for managing organizational productivity. For example, organizational productivity may be used to determine a rate at which an organization may utilize resources (e.g., resources associated with the organization) to achieve outcomes. The ability to achieve outcomes, such as providing products to customers, may provide one or more advantages for the organization. Accordingly, the organization may implement one or more techniques to manage (e.g., and improve) organizational productivity. For example, the organization may use one or more techniques based on management science (e.g., include using OKRs) or behavioral and psychological theories (e.g., regarding employee motivation), such as Maslow's hierarchy of needs, McClelland's three needs theory, Herzberg's motivation theory, Alderfer's existence, relatedness, and growth (ERG) theory, Vroom's Expectancy Theory, the Hawthorne effect, Skinner's operant conditioning theory, and Locke's goal-setting theory.

In some examples, the organization may utilize techniques based on one or more behavioral and psychological theories (e.g., motivational theories) to manage organizational productivity associated with day-to-day operations. Additionally, or alternatively, the organization may use techniques that include one or more organizational designs to manage organizational productivity. The organization may use an organizational design to organize employees (e.g., teams, groups) according to one or more constraints associated with communication within the organization. For example, projects associated with the organization may be partitioned into tasks (e.g., to achieve an outcome). In such an example, to manage organizational productivity associated with the project, the organization may establish lines of communication and interrelationships between the tasks and the employees that may be performing the tasks. In some examples, however, some techniques for managing organizational productivity may fail to capture one or more causes (e.g., problems) associated with reduced productivity, for example due to a relatively complex nature of the organization. For example, some techniques for managing (e.g., improving) organizational productivity fail to accurately capture an interdependency between organizational productivity, organizational potential, and organizational resistance, which may lead to an inaccurate understanding of the organizational productivity within the organization. Moreover, such techniques may lack a mechanism for quantifying organizational productivity, which may lead to unnecessary underachievement.

In some examples, techniques for measuring organizational productivity, as described herein, may use Organizational Ohm's Law (e.g., based on Ohm's Law for electrical current) to develop a model for understanding organizational productivity comprehensively. For example, the model may indicate that organizational productivity corresponds to organizational velocity and organizational velocity is proportional to outcome-output efficiency and organizational potential, and inversely proportional to organizational resistance. In such an example, the model may be used to understand organizational velocity challenges. Additionally, or alternatively, the model may be used for improving organizational velocity. For example, the organization may correspond to a software engineering organization. In such an example, engineering velocity may be used to measure the performance of the software engineering organization. That is, for software engineering organizations organizational productivity may correspond to engineering velocity.

For example, the model developed based on Organizational Ohm's Law may be used as a both a retrospective tool and a predictive tool to manage and improve engineering velocity. For example, the subsystem 125 may use the model to provide, to the software engineering organization (e.g., via a client device 105), analytics associated with the performance of the software engineering organization. In some examples, the software engineering organization may use the analytics to improve engineering velocity, for example by transforming a single product into a product platform, and by migrating from a monolith to microservices and macroservices.

For example, product functionality associated with the software engineering organization (e.g., a tenant served by the subsystem 125) may be designed in a hard-coded manner to satisfy a portion (e.g., about 80%) of customer constraints associated with a product developed at the organization. In some examples, however, increasing complexity in customer constraints may lead to tradeoffs associated with the introduction of features for the product. Further, business associated with the software engineering organization may be expanded to satisfy multiple (e.g., different) categories of customers. That is, an increased quantity of features may be introduced, such that the product may satisfy multiple categories of customers. In some examples, however, the introduction of features for a product may be relatively complex. For example, coupled modules and functions associated with an architecture of the product may include an increased quantity of dependencies. For example, development of features within the architecture may lead to multiple employees of the organization (e.g., engineers, product managers) attending relatively long and relatively frequent status update meetings (e.g., to obtain architectural and product decisions). Additionally, or alternatively, multiple teams may coordinate to modify the modules associated with the product. That is, an organizational resistance associated with the product (e.g., a single product) may be relatively high.

In some examples, the software engineering organization may use the model to better understand the organizational resistance and determine one or more adjustments the software engineering organization may implement to reduce organizational resistance, thereby improving engineering velocity. For example, the subsystem 125 may obtain performance information associated with the software engineering organization from a set of multiple sources. In some examples, the subsystem 125 may obtain performance information from employees associated with the software engineering device (e.g., via the client device 105). Additionally, or alternatively, the subsystem 125 may obtain performance information autonomously (e.g., using APIs). For example, the subsystem 125 may use the APIs to obtain information from a syslog of one or more SaaS applications (e.g., products, one or more applications 110). In some examples, the subsystem 125 may output analytics corresponding to the performance of the organization based on the performance information and one or more rules. The one or more rules may be based on a relationship between a rate of outcomes, an output-outcome efficiency, an organizational potential, and an organizational resistance. That is, the one or more rules may be based on Organizational Ohm's Law (e.g., the model). In some examples, the analytics may indicate that transiting to a product platform may provide a foundation for coupling engineering and product teams with reduced organizational resistance. For example, transition from the single product to the product platform may provide for increased focus within engineering teams, an alignment of goals, and increased motivation. That is, transitioning to the product platform may lead to increased potential associated with engineers (e.g., individual engineers), increased engineering organizational potential, and increased outcome-output efficiency.

Additionally, or alternatively, the output analytics may indicate (e.g., retrospectively) that a codebase monolith used within the software engineering organization (e.g., a Java-based monolith), which may include a code repository, an integrated development environment (IDE) setup, a build artifact, a relatively large runtime, a continuous integration (CI) system, relatively few user interface applications, and a database, may be contributing to increased organizational resistance. For example, the output analytics may indicate (e.g., retrospectively) that the codebase monolith lead to an increased duration for full-builds, monolith runtime startup, switching or rebasing branch, syncing IDE, and completing CI and tests. As such, the output analytics may indicate that the monolith imposed a relatively large infrastructure resistance to engineering teams due to infrastructure friction, and negatively impacted engineering potential (e.g., due to engineer demoralization). In such an example, based on the output analytics, the software engineering organization may determine to separate the monolith into microservices and macroservices, and use product development opportunities to test out the microservices and macroservices code, build, and release. In some examples, the output analytics may indicate (e.g., predict) that over a duration the determination to separate the monolith into microservices and macroservices may provide for reduced infrastructure resistance, process resistance, and structure resistance due to relatively loosely coupled architectures, processes, and organizational structures.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

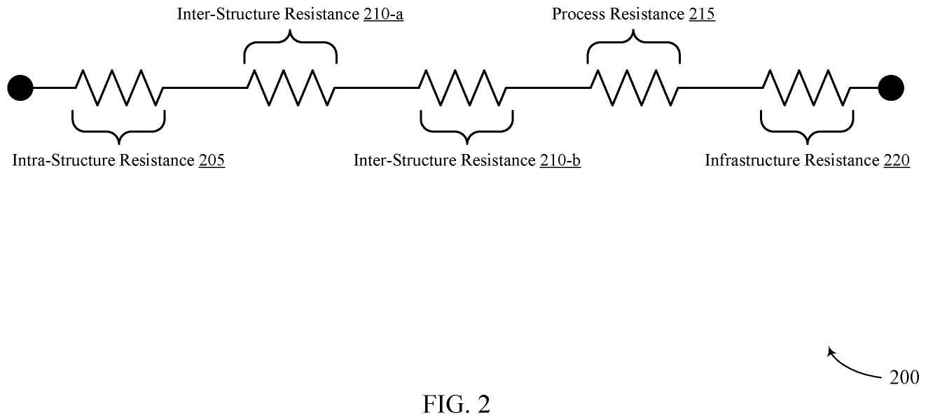

FIG. 2 illustrates an example of a model circuit 200 that supports techniques for measuring organizational productivity in accordance with aspects of the present disclosure. In some examples, the model circuit 200 may implement or be implemented at aspects of the system 100. For example, the model circuit 200 may be implemented at a client device or a software platform, or both, which may be examples of the corresponding devices as described with reference to FIG. 1. In some examples, an organization may use the software platform (e.g., via the client device) to generate the model circuit 200 for improved organizational productivity, among other possible benefits.

In some examples, Organizational Ohm's Law may be utilized retrospectively and predictively. For example, as an analysis tool (e.g., a root cause analysis tool), Organizational Ohm's Law may be used to provide an understanding of organizational productivity. Organizations (e.g., companies) may attempt to apply learnings from experience and techniques used at other organizations (e.g., industry practices). However, organizations may be relatively complex and, as such, implementing industry practices (e.g., direct copy and paste) may be ineffective. That is, an organization may lack an understanding as to how to adjust the industry practices, such that the industry practices may be compatible with the organization. In some examples, an organization may use an Organizational Ohm's Law framework to identify causes (e.g., root causes), and map the industry practices.

Additionally, or alternatively, as a simulation tool, Organizational Ohm's Law may be used to predict an impact of action plans on organizational productivity. For example, by applying the Organizational Ohm's Law framework or generating (e.g., drawing) equivalent circuits for industry practices (or observations), the organization may develop an understanding of the interdependent nature of actions taken within the organization, anticipate potential outcomes, and adjust action plans (e.g., iteratively). In some examples, the simulation process may lead to relatively fast feedback or adjustments, and improve outcomes.

In some examples, organizational velocity may be used to measure organizational productivity. For example, velocity (v) may be used to describe the rate of change of a position in accordance with the following Equation 1:

$$v = \frac{x}{t} \qquad ( 1 )$$

in which v may correspond to velocity, x may correspond to distance, and t may correspond to a quantity of time (e.g., used to travel the distance x). In some examples, a rate of change of a position of an electron (e.g., current) may be described in accordance with the following Equation 2:

$$I = \frac{Q}{t} \qquad ( 2 )$$

in which I may correspond to current and Q may correspond to a quantity of charges. Ohm's Law may state that current (I) through an object is proportional to a voltage applied to the object and inversely proportional to a resistance of the object. For example, in accordance with Ohm's Law, current may be described in accordance with the following Equation 3:

$$I = \frac{V}{R} \qquad ( 3 )$$

in which V may correspond to voltage (e.g., an electric potential difference), and R may correspond to resistance. In some examples, Ohm's Law may be applied to productivity in accordance with the following Equation 4:

I_{outcome}=η×Iₒᵤₜₚᵤₜ (4)
in which I_{outcome} may correspond to outcome current, Iₒᵤₜₚᵤₜ may correspond to output current, and η may correspond to outcome-output efficiency.

In some examples, outcome current (I_{outcome}) may be used to describe organizational velocity, for example in terms of an effective outcome. That is, outcome current may correspond to velocity (e.g., a net useful velocity) that aligns with organizational goals. Output current (Iₒᵤₜₚᵤₜ), however, may describe output-based organizational velocity. Accordingly, outcome-output efficiency (II) may correspond to a ratio of the outcome current to the output current. In some examples, This outcome-output efficiency may describe how efficiently the output current contributes to the outcome current. In some examples, voltage may correspond to organizational potential, which may be described in accordance with the following Equation 5:

V=v̅ᵢ̅(̅S̅k̅i̅l̅l̅s̅,̅M̅o̅t̅i̅v̅a̅t̅i̅o̅n̅)̅ (5)
in which V may correspond to organizational potential, and vᵢ may correspond to individual potential (e.g., potential associated with an individual employee). In some examples, organizational potential may correspond to an average of individual potential (e.g., an average potential for individual employees to complete a job). Multiple factors (e.g., two factors) may contribute to individual potential, such as an skill associated with an employee performing a job (e.g., task, activity, work) and an associated motivation for performing the job. In some examples, the skill associated with an employee may include domain-specific abilities, time management, and interpersonal skills. In some examples, individual potential (V i) may depend on an associated team and the organization. For example, an organization and a team within the organization that includes an employee may impact the individual potential of the employee due to skill and motivation of the employee being enhanced or deteriorated by the environment in which the employee performs the job (e.g., the team and the organization). In some examples, a mission associated with an organization, a culture associated with an organization, a meaning of work performed by the employee, a relationship between the employee and other employees of the organization (e.g., management and colleagues), and financial incentives may contribute to employee motivation.

In some examples, organizational resistance may correspond to an opposition that an organization may impose on a flow of outputs and outcomes. Organizational resistance may include multiple (e.g., three) types of friction with an organization, including structure resistance, infrastructure resistance, and process resistance. For example, organizational resistance may be described in accordance with the following Equation 6:

R=R^{structure}+R^{process}+R^{infrastructure} (6)
in which R may correspond to organizational resistance, R^{structure} may correspond to structure resistance, R^{process} may correspond to process resistance, and R^{infrastructure} may correspond to infrastructure resistance. In some examples, an organizational structure may define how activities are directed to achieve goals of an organization. Some activities may include performing work, while other activities may include communicating information to conduct the work (or waiting for the completion of dependencies by others). In some examples, organizational structure may determine how information and decisions flow between levels within an organization. For example, communication to reach agreements may not contribute (e.g., directly) to organizational outputs and outcomes, and may be relatively costly. As such, the communication may lead to structure resistance within an organization. Additionally, structure resistance may have dependence on organizational potential. For example, a collaborative culture may reduce friction associated with communication and, accordingly, reduce structure resistance.

Organizational processes may include processes, procedures, and programs used within organizations to complete jobs (e.g., tasks, work). In some examples, ineffective processes may impact organizational outcomes due to employees using time (e.g., unnecessarily) navigating the processes (e.g., organizational bureaucracy), which may lead to increased process resistance. Organizational infrastructure may include physical and technological infrastructure. For example, some teams (e.g., informational technology (IT)) within an organization may be tasked with improving an infrastructure (e.g., an overall infrastructure) of the organization, such that employees may perform jobs more effectively, which may lead to reduced infrastructure resistance. For example, output and outcomes of a team (e.g., an internal team) may serve as infrastructure for other teams to reduce difficulties associated with jobs performed by the other teams. Moreover, structure resistance, process resistance, and infrastructure resistance may be interdependent. For example, the process of reducing organizational resistance may include, at least partially, a process of identifying correspondence (e.g., matching points) between employees, processes, and infrastructure. Additionally, if a task is formalized into a process, structure resistance may converge with process resistance. In some examples, if a routine process is developed into a workflow, process resistance may converge with infrastructure resistance. In some examples, convergence of resistance (e.g., resistance transformation) may reduce variability among employees and reduce organizational resistance.

In some examples, in accordance with Organizational Ohm's Law, outcome current (e.g., organizational velocity) may be proportional to outcome-output efficiency and organizational potential, and inversely proportional to organizational resistance. For example, outcome current may be described in accordance with the following Equation 7:

$${I}_{outcome} = η \times \frac{V}{R} = η \times \frac{\overline{{v}_{i} ( Skills , Motivation )}}{{R}^{structure} + {R}^{process} + {R}^{infastructure}} \qquad ( 7 )$$

in which I_{outcome} may correspond to the outcome current, η may correspond to outcome-output efficiency, V may correspond to organizational potential, and vᵢ may correspond to individual potential, R may correspond to organizational resistance, R^{structure} may correspond to the structure resistance, R^{process} may correspond to process resistance, and R^{infrastructure} may correspond to infrastructure resistance. In accordance with Equation 7, outcome current may be increased (e.g., is the maximize) under organizational resource constraints. In some examples, organizational resource constraints may include budget and schedule constraints (e.g., an organization may achieve outcomes using a quantity of money and in accordance with a deadline). In some examples, an action performed by an organization may lead to changes in one or more parameters and, as such, the parameters may be determined according to the relatively near-term and relatively long-term goals of an organization.

In some examples, the organization may include an engineering organization, such as a software engineering organization. In such an example, Organizational Ohm's Law may be used to determine engineering velocity. That is, one or more parameters associated with Equation 7 (e.g., I_{outcome}, η, V, R) may be determined in the context of a software engineering organization. In some examples, multiple factors and an interdependence of the multiple factors may impact a respective value of the parameters. As such, multiple factors may be adjusted to improve the respective values of the parameters, thereby improving outcome-based engineering velocity.

As illustrated in the example of FIG. 2, an equivalent circuit may be used to illustrate an impact of organizational structures on engineering velocity. For example, for some software engineering projects, such as agile software development, engineering velocity may be a metric for completed work. As such, the velocity metric (e.g., engineering velocity) may be used for project planning (e.g., planning sprints) and measuring team performance. In some examples, agile velocity may be considered an example of output-based velocity, which may correspond to a metric for tracking output over time (e.g., a quantity of story points a team may complete in a given sprint). For a product-focused engineering team, if the outputs of a project contribute to a goal of delivering functional products, the effort may contribute to outcome-based engineering velocity. In some examples, the effort may contribute to an outcome-based organizational velocity, for example if the output contributes to product releases that may be expected to generate revenue and profit in the near-term or long-term. In some examples, it may be relatively difficult to improve outcome-output efficiency in software engineering. For example, engineering teams may balance between activities that contribute to the daily uptime of a system or application (e.g., keep-the-lights-on activities), such as maintaining product reliability and security, providing ongoing customer support, reducing tech debt, and new product development. Additionally, or alternatively, more products and features may be planned than may be output. As such, engineering organizations may determine to work toward relatively few goals during a duration. In some examples, the engineering organization may prioritize one or more goals over other goals, for example with autonomy, reduced distraction, and reduced context switches. In some examples, some employees of an organization (e.g., single-threaded leaders) may enable other employees to focus on a single prioritized goal (e.g., with autonomy, reduced distraction, and reduced context switches).

Organizational and individual potential may be determined in the context of a software engineering organization. For example, changes associated with a software development field (e.g., cloud computing, virtualization, containerization, artificial intelligence, and blockchain) may occur relatively quickly. For example, web development evolved from text-based static websites, to the trinity of Hypertext Markup Language (HTML), Cascading Style Sheets (CSS), and JavaScript, to various modern web application technologies over a relatively short duration. Consequently, engineers may improve skills and knowledge over a relatively short duration. In some examples, a dynamic environment in which changes occur relative quickly may implies a relatively short knowledge lifespan of software development skills, which may foster continuous learning. In some examples, opportunities to learn and use technologies may motivate engineers. Additionally, engineers may be highly motivated to refresh knowledge due to relatively high market demands and compensation. In some examples, a culture of innovation may increase motivation. For example, events (e.g., Hackathons) may be used in engineering organizations to encourage engineering creativity and cross-team collaboration. In some examples, an organization may empower engineers is by enabling the engineers to participate in decisions about work. As such, to increase the organizational potential of an engineering organization, the organization may invest resources in engineering processes or enhance engineering compensation.

In some examples, organizational resistance of an engineering organization may correspond to an aggregation of the structure resistance, process resistance, and infrastructure resistance of the engineering organization. For example, communication costs within and across engineering teams may reflect the structure resistance of the engineering organization. Additionally, or alternatively, process resistance of an engineering organization may correspond to process friction of performing engineering work. Agile planning, post-mortem, retrospective, code review, release process, security review, and legal review may be examples of engineering-specific process resistance. In some examples, organization-wide processes, such as goal setting, planning, budgeting, financial procedures, performance review and feedback, may also contribute to the process resistance of engineering. As described herein, infrastructure resistance of engineering may refer to friction of performing engineering work. In some organizations that practice agile and development IT operations (DevOps), teams associated with engineering infrastructure may be referred to as platform teams. In some examples, strategies for reducing engineering-specific infrastructure resistance may include relatively loosely coupled architectures, codebases with manageable technology debt, improved version control, relatively effective continuous integration and continuous delivery (CI/CD) pipelines, suitably managed manual and automatic tests, and easy-to-find and read documentation. Additionally, or alternatively, organization-wide infrastructure friction, such as IT and workspace effectiveness, may contributes to infrastructure resistance of engineering organizations. In some examples, improvements in process and infrastructure resistance may necessitate purchasing or upgrading tools and implementing or improving processes. That is, improvements (e.g., investments) may use money (e.g., in terms of salaries for employees working on improvements and cost of tools) and time (e.g., in terms of duration to establish suitable processes and infrastructure).

In some examples, industry practices may be mapped in accordance with Table 1. For example, in accordance with Table 1, industry practices for improving engineering velocity may be mapped to corresponding variables in Organizational Ohm's Law. For example, Table 1 may illustrate that Organizational Ohm's Law provides a tool for modeling engineering velocity challenges by correlating various interdependent aspects.

TABLE 1

| | Outcome- | | Organizational Resistance | | |
|---|---|---|---|---|---|
| Engineering | Output | Organizational | Structure | Process | Infrastructure |
| Velocity | Efficiency | Potential | Resistance | Resistance | Resistance |
| Example | OKR, | motivation | Conway's | agile, | loosely |
| Industry | aligned | theories, | Law, | CI/CD, | coupled |
| Practices | goal, single- | culture of | Brooks's | code/ | architectures, |
| | threaded | trust, | Law, two- | security | CI/CD |
| | leaders | collaboration, | pizza | review, | pipelines, |
| | | learning, | principle, | Hackathon/ | test and |
| | | innovation, | squad, tribe, | demo day | release, docs, |
| | | autonomy, | chapter, | office hours/ | group chats/ |
| | | incentives, | guild | tech talks, | mailing lists/ |
| | | recognition | | dog food | Q&A |
| | | | | | platform |

As illustrated in the example, of FIG. 2, a model circuit 200 may be used to identify organizational resistance in a software engineering organization. For example, Organizational Ohm's Law may be used to describe organizational velocity using an equivalent circuit (e.g., a theoretical circuit and its electrical characteristics to represent an organization and the interactions within the organization). In some examples, an independent engineering team m, which may be used to build products, may be associated with some organizational resistance (R_{eng_m}). As described herein, teams use to build products may be referred to as workstream teams. In some examples, work associated with a workstream team may contribute to the outcome current of an organization including the workstream team. Additionally, or alternatively, the organizational resistance of an engineering team m may include intra-structure resistance 205 of the engineering team m (R_{eng_m}^{structure}), inter-structure resistance 210-a between the engineering team m and an engineering infrastructure team (R_{eng_m,eng_infra}^{structure}), inter-structure resistance 210-b between the engineering team m and a process team (R_{eng_m,eng_process}^{structure}), process resistance 215 (R_{eng_m}^{process}), and infrastructure resistance 220 (R_{eng_m}^{infrastructure}). As illustrated in the example of FIG. 2, the resistors representing the intra-structure resistance 205, the inter-structure resistance 210-a, the inter-structure resistance 210-b, the process resistance 215, and the infrastructure resistance 220 may be in series due to the engineering team m experiencing the corresponding resistance to achieve an output. In some examples of the model circuit 200 (e.g., an equivalent circuit), the organizational resistance of the engineering team m may be based on the engineering team m interacting with organization-level processes and infrastructure through the engineering process and infrastructure teams. In some other examples, a company process resistance (R_{eng_m,company_process}^{structure}) and a company infrastructure resistance (R_{eng_m,company_infra}^{structure}) may be included in the model circuit 200 to describe the communication resistance (e.g., friction) between team m and company process and infrastructure teams, respectively.

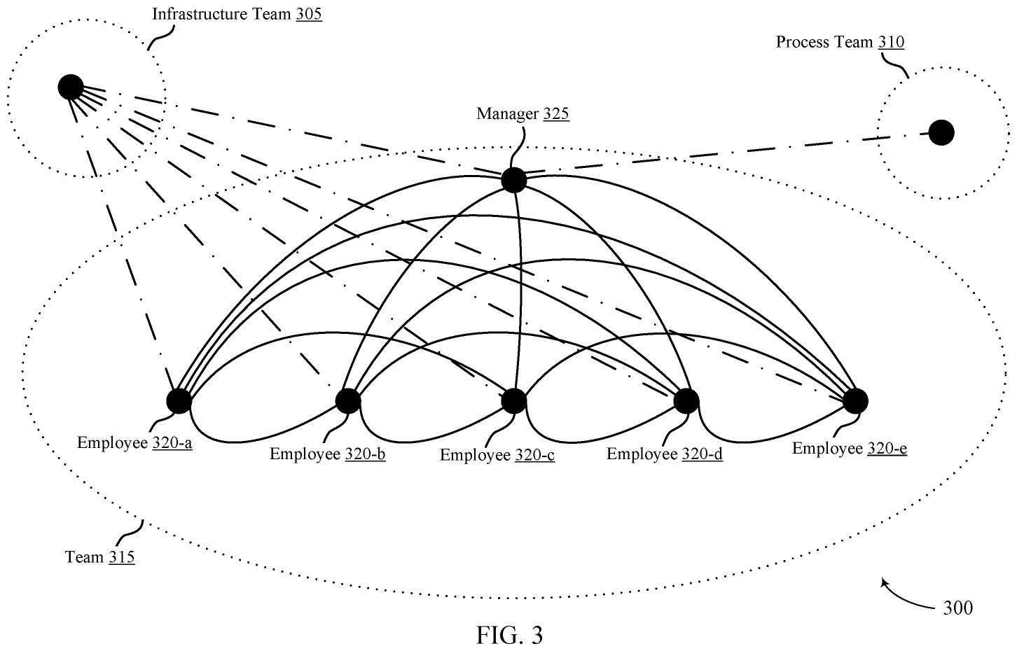

FIG. 3 illustrates an example of a communication pathway 300 that supports techniques for measuring organizational productivity in accordance with aspects of the present disclosure. In some examples, the communication pathway 300 may implement or be implemented at aspects of the system 100 and the model circuit 200. For example, the communication pathway 300 may be implemented at a client device or a software platform, or both, which may be examples of the corresponding devices as described with reference to FIGS. 1 and 2.

In some examples, a value of structure resistance may be proportional to a cost of communication. For example, structure resistance may be described in accordance with the following Equation 8:

R^{structure}˜Σₚ_{ᵢ}wᵢ (8)
in which pᵢ may correspond to an ith communication path, and wᵢ may correspond to a cost associated with the ith path. In some examples, the cost of communication may correspond to a quantity of time use to achieve a communication goal. For example, a quantity of time used by an employee 320 (e.g., an employee 320-a, an employee 320-b, and employee 320-c, an employee 320-d, and an employee 320-e) to determine suitable ways to work with other employees 320 to obtain inputs (e.g., from the other employees 320) may be longer than a communication pathway itself. As such an organization may establish trust and collaboration between team members (e.g., the employees 320) and across teams to facilitate relatively effective communication. Additionally, or alternatively, a manager 325 of a team 315 (e.g., and technical program managers) may be used to reduce communication obstacles (e.g., roadblocks). In some examples, communication within the team 315 may be relatively less costly than across teams, which may imply that a relatively small autonomic team may be a desirable organizational structure for delivering outputs.

As illustrated in the example of FIG. 3, multiple communication paths may be established for the team 315 (e.g., an engineering team, a workstream team). For example, the team 315 may include a five employees (e.g., the employees 320) and the manager 325. In such an example, a quantity of team members included in the team 315 may correspond to 6 (e.g., N=6). In the example of FIG. 3, a quantity of bidirectional communication paths within the team 315 may correspond to 15 (e.g., N(N−1)/2=15) and a quantity of directional communication paths for intra-structure resistance may correspond to 30 (e.g., N(N−1)=30). In such an example, as the size of the team 315 increases, the intra-structure resistance may also increase, for example proportionally to the square of the size of the team 315. In some examples, engineers (e.g., the employees 320) may be exposed to engineering and organizational processes (e.g., from a process team 310) through the manager 325 as an intermediary. For example, the manager 325 may serve as an inter-team interface between the employees 320 and the process team 310 to cascade policy information and enforce process execution. In some examples, each member of the team 315 (e.g., the employees 320 and the manager 325) may interact with an infrastructure team 305 (e.g., an engineering infrastructure team), which may contribute to inter-structure resistance (e.g., each employee 320 may receive training on how engineering processes work to enable interactions with the infrastructure team 305). The inter-structure resistance of the team 315 and the infrastructure team 305 may decrease subsequent to the employees 320 receiving training.

In some examples, in accordance with Organizational Ohm's Law, outcome current, and hence organizational velocity, may be proportional to outcome-output efficiency and organizational potential, and inversely proportional to organizational resistance. For example, outcome current may be described in accordance with the following Equation 9:

$${I}_{outcome} = η \times \frac{V}{R} = η \times \frac{\overline{{v}_{i} ( Skills , Motivation )}}{{R}^{structure} + {R}^{process} + {R}^{infastructure}} \qquad ( 9 )$$

In some examples, Equation 9 may be used as a framework to understand organizational velocity (e.g., engineering velocity) retrospectively and predictively. For example, Ohm's Law may be applied to organizations to relate organizational velocity with outcome-output efficiency, organizational potential, and organizational resistance. Additionally, or alternatively, Ohm's Law may be applied to organizations to identify outcome-output efficiency, organizational potential, and organizational resistance and to identify interactions between outcome-output efficiency, organizational potential, and organizational resistance. In some examples, Organizational Ohm's Law may be used to derive engineering velocity measurement metrics. For example, outcome current may be described in accordance with the following Equation 10:

$${I}_{outcome} = \frac{O}{T} \qquad ( 10 )$$

in which O may represent an outcome and T may represent a quantity of time used to achieve the outcome. In some examples, in product development, the quantity of time used to achieve an outcome may be based on one or more events (e.g., milestones), such as a beginning of feature development, early availability (EA) of the features, general availability (GA), and ongoing development and support. Additionally, or alternatively, outcome current may be described in accordance with the following Equation 11 and Equation 12:

$${I}_{outcome} = η \times \frac{\overline{v}}{{R}^{self} + {R}^{collaboration} + {R}^{process} + {R}^{infastructure}} \qquad ( 11 )$$

$${I}_{outcome} = C \times η \times \frac{\overline{v}}{\frac{\overline{{t}^{self}} + \overline{{t}^{collaboration}} + \overline{{t}^{process}} + \overline{{t}^{infastructure}}}{\overline{{t}^{self}}}} \qquad ( 12 )$$

in which R^{self} may correspond to self resistance, R^{collaboration} may correspond to collaboration resistance, R^{process} may correspond to process resistance, R^{infrastructure} may correspond to infrastructure resistance, t^{self} may correspond to a quantity of time used for self engineering development, t^{collaboration} may correspond to a quantity of time used for collaboration, t^{process} may correspond to a quantity of time used for processes, t^{infrastructure} may correspond to a quantity of time used for inefficient infrastructure, and C may correspond to a constant. In some examples, outcome current may be described in accordance with the following Equation 13, Equation 14, and Equation 15:

$${I}_{outcome} = \approx η \times \frac{N \times \overline{v}}{\overline{{r}^{self}} + \overline{{r}^{collaboration}} + \overline{{r}^{process}} + \overline{{r}^{infastructure}}} \qquad ( 13 )$$

$${I}_{outcome} = C \times η \times N \times \overline{v} \frac{1}{\frac{\overline{{t}^{self}} + \overline{{t}^{collaboration}} + \overline{{t}^{process}} + \overline{{t}^{infastructure}}}{\overline{{t}^{self}}}} \qquad ( 14 )$$

$${I}_{outcome} = C \times η \times N \times \overline{v} \times \frac{\overline{{t}^{self}}}{\overline{{t}^{self}} + \overline{{t}^{collaboration}} + \overline{{t}^{process}} + \overline{{t}^{infastructure}}} \qquad ( 15 )$$

in which r^{self} may correspond to self resistance for an employee, r^{collaboration} may correspond to collaboration resistance for an employee, r^{process} may correspond to process resistance for an employee, R^{infrastructure} may correspond to infrastructure resistance for an employee, and N may correspond to a quantity of employees within the organization (e.g., within the team 315). In some examples, outcome current may be described in accordance with the following Equation 16:

$${I}_{outcome} = C \times η \times N \times \overline{v} \times \frac{\overline{{t}^{self}}}{\overline{{t}^{total}}} \% \qquad ( 16 )$$

in which t̅^̅{̅t̅o̅t̅a̅l̅}̅ may correspond to a quantity of time used for work.

In some examples, outcome current, which may represent organizational velocity, may be described as outcome during a time period, as shown in Equation 10. Outcomes may depend on a nature of an organization and objectives of the organization. For example, a non-profit organization may define objectives in terms of serving communities, while for-profit organizations may define objectives in terms of increasing financial returns for shareholders and stakeholders. Objectives of engineering, product, and design organizations may be to output product features for customers. In some examples, outputs that align with the objectives of the organizations may be referred to as outcomes.

In some examples, engineering outcomes may be defined as a summation of goals, and the goals may be weighted by size and difficulty. From a customer perspective, customer satisfaction with a product feature may represent outcome current. Feature usage and a value the feature usage may imply may be used to measure the outcome current. In some examples, a usage approach may provide one or more advantages. For example, a usage metric (e.g., a measure of use of a feature by a customer) may be objective (e.g., within a quantity of biases). Additionally, or alternatively, consumer products and SaaS enterprise applications may be used to obtain historical and dynamic (e.g., real-time) feature usage data, such as a quantity of events triggering the features or a quantity of users and customers using the features. In some examples, usage data may be based on (e.g., linked directly) with company revenue models.

In some examples, outcome-output efficiency may be used to quantify how output aligns with outcome. For example, delivering products that customers use may be a goal of an engineering organization (e.g., the team 315). In such an example, customer satisfaction scores for features associated with the product may be used to represent the outcome-output efficiency. In some examples, a survey may be used to collect data regarding customer satisfaction. For example, survey results (e.g., internally), such as feature satisfaction scores from a sales team may be used to represent the outcome-output efficiency.

Additionally, or alternatively, organizational potential may correspond to an average of individual potential. For example, individual potential may reflect employee motivation and skill (e.g., a motivation and skill of each employee 320). A value of individual potential may be assessed using employee surveys. For example, a survey may include questions regarding how motivated and how skillful an engineer (e.g., the employees 320) may be at performing one or more jobs. Additionally, or alternatively, the individual potential may be interpreted from employee satisfaction scores, turnover rates, management ratings, culture scores, and employee performance reviews, among other examples.

In some examples, organizational resistance may correspond to a summation of structure resistance, process resistance, and infrastructure resistance. For example, structure resistance may include self resistance (R^{self}) and collaboration resistance (R^{collaboration}) as shown in Equation 11. In some examples, self resistance may be modeled as intrinsic resistance from copper wire. For example, self resistance may correspond to a threshold resistance (e.g., a minimum resistance or another suitable quantity of resistance) an engineer may impose on an organization. That is, self resistance may correspond to a threshold quantity of resistance with a hypothetical assumption that the engineer may perform the work without collaboration and in accordance with processes and infrastructure. Collaboration resistance may correspond to a resistance due to project communication and dependencies. In some examples, process resistance (R^{process}) may correspond to a resistance imposed by following engineering and company processes, and infrastructure resistance (R^{infrastructure}) may correspond to a resistance due to inefficient infrastructure.

In some examples, a software platform may be used to determine organizational resistance. For example, to determine organizational resistance, the software platform may determine (e.g., obtain information regarding) a quantity of time engineers (e.g., the employees 320) use to perform one or more tasks. That is, to measure organizational resistance, the software platform may measure the quantity of time engineers use to perform various activities normalized to a quantity of time used to perform core engineering activities. In some examples, core engineering activities may correspond to engineering activities an engineer performs without communication and dependencies. Additionally, or alternatively, the core engineering activities may include activities associated with efficient engineering processes and infrastructure for performing the activity.

In some examples, a value of self resistance may be proportional to a quantity of time used for core engineering activities. A value of collaboration resistance may be proportional to a quantity of time used for communication and dependencies. A value of process resistance may be proportional to a quantity of time used to complete processes. A value of infrastructure resistance may be proportional to a quantity of time used due to inefficient infrastructure. In some examples, team resistance may be constructed from individual engineer resistance using an equivalent circuit approach. For example, the software platform may output (e.g., generate) a model circuit for the team 315 based on an organizational resistance determined for the team 315.

In some examples, an average organizational resistance of the employees 320 divided by the quantity of employees 320 may correspond to (e.g., approximately) the organizational resistance. As such, an average time the employees 320 use for various activities, divided by the quantity of time used for core engineering activities, divided by the quantity of employees may correspond to organizational resistance. Additionally, output current may be proportional to outcome-output efficiency multiplied by the quantity of employees 320 (e.g., engineers) in the team 315, multiplied by the average employee individual potential, multiplied by the average percentage of time used for core engineering activities. That is, as shown in Equation 16, the percentage of time used for core engineering activities may contribute to outcome current (e.g., engineering velocity). For example, a quantity of time used by one or more of the employees 320 on non-core engineering activities may not contribute to engineering velocity.

In some examples, with modern engineering software and hardware, the quantity of time used on various activities may be collected from usage data of employee work tools. For example, calendar software provides durations used for meetings and non-meetings, collaboration software may track communication durations, laptops and workstations may provide screen time reports, commit activities may be used to estimate coding time, and ticket data may be analyzed for wait time for dependencies. Additionally, or alternatively, data regarding the quantity of time used for various activities may be obtained using survey data from engineers (e.g., the employees 320) or managers (e.g., the manager 325).

In some examples, to obtain output current for a feature the software platform may obtain usage data for the feature. Additionally, the software platform may determine a unit revenue impact of each usage unit and multiply the usage by the unit revenue impact to obtain a revenue impact of the feature. In some examples, the software platform may obtain accumulated revenue impact over a first quantity of time. For example, the feature may be selected from a set of product features developed by the team 315 over the first quantity of time (e.g., a year). In such an example, the team 315 may have used a second quantity of time (e.g., about 10 months) to develop the feature to EA, and a third quantity of time (e.g., about 8 months) to develop the feature to GA. In some examples, the first quantity of time used to obtain accumulated revenue impact may occur subsequent to GA (e.g., may be obtained over about 6 months after GA). In some examples, the software platform (e.g., in accordance with the model) may divide the accumulated revenue impact by feature development (e.g., time to GA) to obtain output current.

In some examples, to obtain outcome-output efficiency of the product feature the software platform may use a product and engineering survey. For example, the software platform may survey a sales team to determine an innovation and impact of one or more product features developed by the team 315. Additionally, or alternatively, to achieve organizational potential and organizational resistance, the software platform may obtain engineering productivity metrics. In some examples, the software platform may obtain engineering productivity metrics using a survey. For example, the software platform may survey engineering managers (e.g., the manager 325) for engineering productivity metrics. In some examples, the survey may include questions regarding an average quantity of time (e.g., hours per week) the employees 320 perform work or a percentage of time the employees use to perform various activities. In some examples, multiplying a motivation score of the team 315 with a skill sore of the team 315 may provide a score that reflects organizational potential.

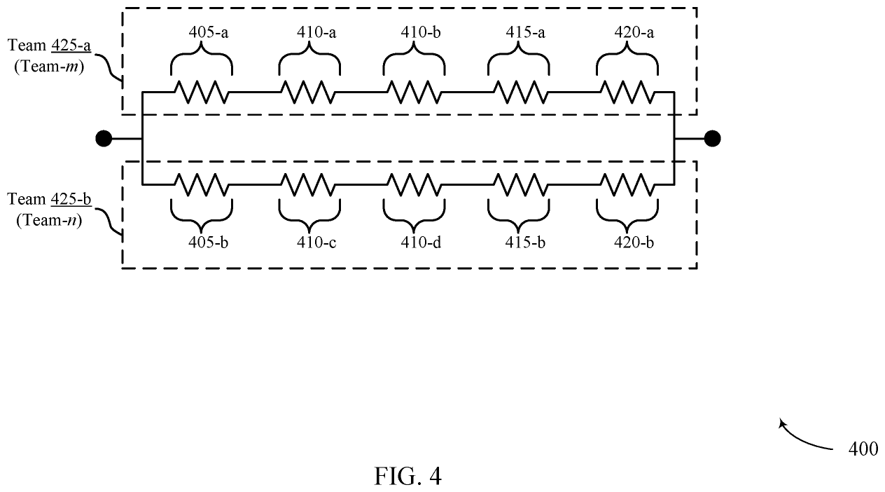

FIG. 4 illustrates an example of a model circuit 400 that supports techniques for measuring organizational productivity in accordance with aspects of the present disclosure. In some examples, the model circuit 400 may implement or be implemented at aspects of the system 100, the model circuit 200, and the communication pathway 300. For example, the model circuit 400 may be implemented at a client device or a software platform, or both, which may be examples of the corresponding devices as described with reference to FIGS. 1 through 3. In some examples, an organization may use the software platform (e.g., via the client device) to generate the model circuit 400 for improved organizational productivity, among other possible benefits.

In some examples, an organizational equivalent circuit approach may be used for non-workstream teams. In such examples, however, the output of non-workstream teams may not contribute to engineering organizational velocity explicitly. In other words, the organizational resistance of non-workstream teams may not be connected to engineering organizational resistance. Additionally, or alternatively, output of non-workstream teams may be attributed to a reduction of process resistance or infrastructure resistance, and an improvement of outcome-output efficiency or organizational potential. For example, efforts of technical program managers may contribute to process resistance reduction, efforts of internal infrastructure teams may contribute to infrastructure resistance reduction, and efforts of engineering leadership may improve the organizational potential and outcome-output efficiency. As illustrated in the example of FIG. 4, independent and dependent workstream teams may work together. Although the example of FIG. 4 is described in the context of workstream teams, it should be understood that the organizational equivalent circuit approach and observations from workstream teams may also be applicable to other types of teams, including process and infrastructure teams.

In some examples, an engineering organization may include multiple workstream teams (e.g., may increase from one workstream team to two). For example, the model circuit 400 may include a team 425-a (e.g., team m) and a team 425-b (e.g., team n), which may each build products (e.g., independently). In such examples, due to both the team 425-a (e.g., engineering team m) and the team 425-b (e.g., engineering team n) contributing to the engineering output current, the model circuit 400 may include two organizational resistors in parallel to each other. In some examples, a relatively higher output current may be achieved by increasing a quantity of engineering teams. For example, the organizational resistance of the teams 425-a and the team 425-b may be equivalent.

In some examples, the model circuit 400 may include intra-structure resistance 405-a of the engineering team m, intra-structure resistance 405-b of the engineering team n, inter-structure resistance 410-a between the engineering team m and an engineering infrastructure team, inter-structure resistance 410-c between the engineering team n and the engineering infrastructure team, inter-structure resistance 410-b between the engineering team m and a process team, inter-structure resistance 410-d between the engineering team n and the process team, process resistance 415-a for the engineering team m, process resistance 415-b for the engineering team n, infrastructure resistance 420-a for the engineering team m, and infrastructure resistance 420-b for the engineering team n. In such an example, using multiple workstream teams (e.g., adding a second independent workstream team) may lead to reduced organizational resistance (e.g., by about half) and increased output current (e.g., about double output current). In some examples, however, increasing the quantity of teams may not lead to increased output current. For example, an independent team structure may not be suitable for increasing engineering organizations.

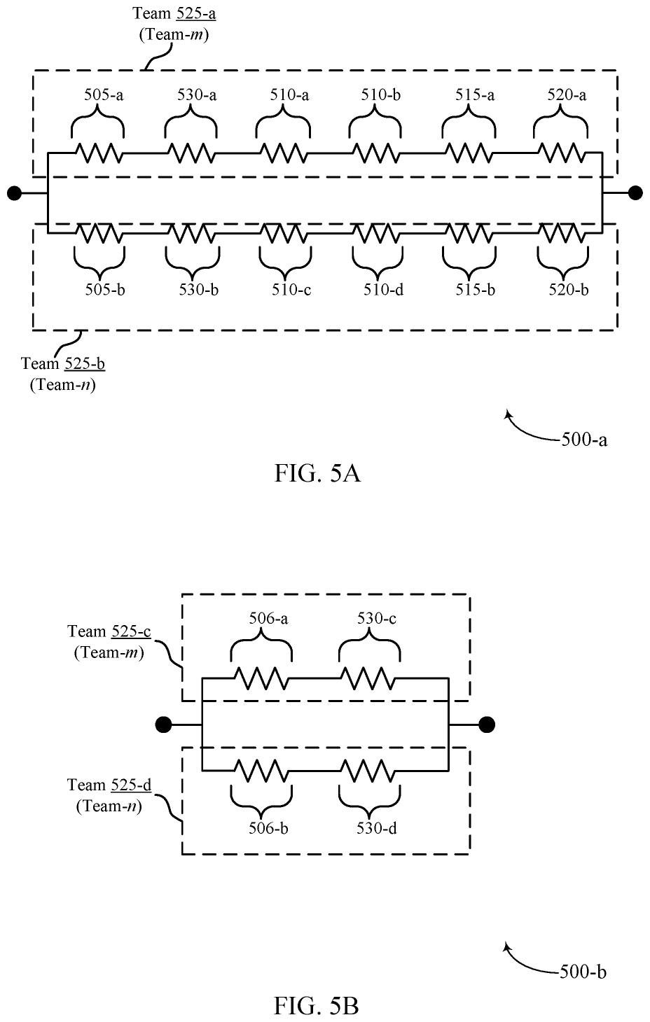

FIGS. 5A and 5B illustrate examples of a model circuit 500 that supports techniques for measuring organizational productivity in accordance with aspects of the present disclosure. In some examples, the model circuits 500 (e.g., a model circuit 500-a and a model circuit 500-b) may implement or be implemented at aspects of the system 100, the model circuit 200, the communication pathway 300, and the model circuit 400. For example, the model circuits 500 may be implemented at a client device or a software platform, or both, which may be examples of the corresponding devices as described with reference to FIGS. 1 through 4. In some examples, an organization may use the software platform (e.g., via the client device) to generate the model circuits 500 for improved organizational productivity, among other possible benefits.

In some examples, dependencies between engineering teams may constrain an increase in output current. For example, proportional engineering velocity improvement may not be achieved in response to adding engineering teams. As illustrated in the example of FIG. 5A, a model circuit 500-a (e.g., an equivalent circuit) may be generated for two dependent engineering teams in which the two engineering teams work on multiple (e.g., two different) workstreams, such as a team 525-a (e.g., team m) and a team 525-b (e.g., team n). In such an example, a dependent organizational resistance (R_{eng}^{organizational_dep) of a team (e.g., the team 525-}a, the team 525-b) may be equal to an independent organizational resistance (R_{eng}^{organizational_ind}) summed with an inter-structure resistance between the team 525-a and the team 525-b, such as inter-structure resistance 530-a (R_{eng_n,eng_m}^{structure}) and inter-structure resistance 530-b (R_{eng_m,eng_n}^{structure}), respectively. That is, the model circuit 500-a may include intra-structure resistance 505-a of the engineering team m, intra-structure resistance 505-b of the engineering team n, inter-structure resistance 530-a between the engineering team m and the engineering team n, inter-structure resistance 530-b between the engineering team n and the engineering team m, inter-structure resistance 510-a between the engineering team m and an engineering infrastructure team, inter-structure resistance 510-c between the engineering team n and the engineering infrastructure team, inter-structure resistance 510-b between the engineering team m and a process team, inter-structure resistance 510-d between the engineering team n and the process team, process resistance 515-a for the engineering team m, process resistance 515-b for the engineering team n, infrastructure resistance 520-a for the engineering team m, and infrastructure resistance 520-b for the engineering team n.

As illustrated in the example of FIG. 5B, a model circuit 500-b (e.g., a simplified equivalent circuit) may be generated using the model circuit 500-a. For example, the model circuit 500-b may include two engineering teams that may work on multiple (e.g., two different) workstreams, such as a team 525-c (e.g., team m) and a team 525-d (e.g., team n). In some examples, values of the inter-structure resistance between the team 525-c and the team 525-d (e.g., inter-structure resistance 530-c between the team 525-c and the team 525-d and inter-structure resistance 530-d between the team 525-d and the team 525-c) may be different (or the same) irrespective of a mutuality of communication. For example, the model circuit 500-b may include independent organizational resistance 506-a of the engineering team m, independent organizational resistance 506-b of the engineering team n, inter-structure resistance 530-c between the engineering team m and the engineering team n, and inter-structure resistance 530-d between the engineering team n and the engineering team m.

For instance, team m may use help from team n, in which team m may use more effort into initiate, follow up, and obtain results from team n. In some examples, the team 525-c (e.g., team m) and the team 525-d (e.g., team n) may include five employees (or some other suitable quantity of employees) and a manager (e.g., N=6). In such examples, a quantity of directional communication paths between members may be used as an approximation of structure resistance. For example, the structure resistance, process resistance, and infrastructure resistance of the team 525-c and the team 525-d (e.g., as well as the engineering process team and the infrastructure team) may be small relative to the intra-structure and inter-structure resistance of the team 525-c and the team 525-d. Additionally, or alternatively, members of the team 525-c and the team 525-d may communicate bi-directionally with other members of the team 525-c and the team 525-d, and a communication costs may be about the same (e.g., equivalent). In some examples, the intra-structure resistance may be about 30 and the inter-structure resistance may be about 36 for the team 525-c and the team 525-d. In such an example, organizational resistance may converge to about 30 and the organizational resistance of the team 525-c and the team 525-d (e.g., together) may be about 33 (e.g., (30+36)/2=33. That is, by using two teams (e.g., by introducing a second team), the organizational resistance increased, thereby decreasing the output current and engineering velocity.

In some examples, a cause for the decrease in engineering velocity (e.g., due to increases the quantity of teams) may be due to inter-structure resistance. For example, cross-team communication may introduce more degradation in engineering velocity due to a cost of cross-team communication being relatively higher than that of intra-team communication. Some work in organization design may aim to reduce unnecessary inter-structure resistance between teams by improving inter-team communication. For example, Conway's law, inverse Conway maneuver, Brooks's law, and the two-pizza rule suggest reducing inter-team structure resistance by designing organizational structure and communication paths that mirror technology and product structures. In some examples, supervisor-subordinate communication may be more costly than subordinate-subordinate communication. For a team with multiple layers of management, delegating decisions and empowering less senior employees to perform inter-team interface roles may reduce inter-structure resistance.

In some examples, an equivalent circuit may be generated for two dependent engineering teams (e.g., the engineering team m and the n) in which the two engineering teams work together to deliver one workstream. In such examples, a team may output work to another other team to complete the workstream. For example, the team m may output work to the team n to complete the workstream. Additionally, or alternatively, the two teams may collaborate to output a solution for a workstream. In some examples, independent organizational resistors and inter-team resistors may be in series with each other, for example due to the teams performing the workstream together. In some examples, work handover and team collaboration may be relatively less efficient from a structure resistance perspective. However, work handover and team collaboration may be performed due to multiple teams being used for an end-to-end workstream due to technical, organizational, managerial, cultural, legal, and cost considerations.

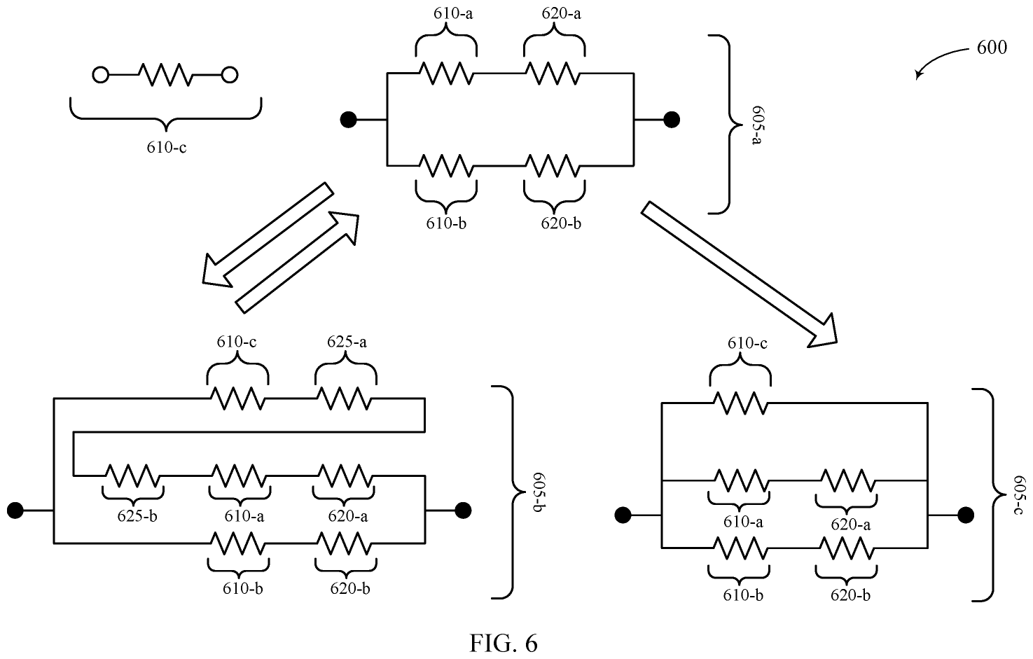

FIG. 6 illustrates an example of an engineering team diagram 600 that supports techniques for measuring organizational productivity in accordance with aspects of the present disclosure. In some examples, the engineering team diagram 600 may implement or be implemented at aspects of the system 100, the model circuit 200, the communication pathway 300, the model circuit 400, and the model circuits 500. For example, the engineering team diagram 600 may be implemented at a client device or a software platform, or both, which may be examples of the corresponding devices as described with reference to FIGS. 1 through 4, 5A, and 5B. In some examples, an organization may use the software platform (e.g., via the client device) to generate the engineering team diagram 600 for improved organizational productivity, among other possible benefits. Although the example of FIG. 6 is described in the context of an engineering team, it is to be understood that the techniques described herein may apply to other types of teams, such as product teams and sales teams, among other examples, and the examples described herein should not be considered limiting to the scope covered by the claims or the disclosure.

In some examples, an organization may include centralized engineering teams, such as the office of a chief technology officer (CTO), research, or special project groups. Such teams may be tasked with technology challenges, innovative products, or building disruptive businesses. In some examples, retaining investment may be a priority for longevity, attracting talent, and preserving idiosyncratic culture, which may be rationales for establishing centralized engineering teams. Additionally, or alternatively, reducing organizational resistance may be a rationale for including centralized engineering teams. As illustrated in the example of FIG. 6, in a state 605-a (e.g., a normal state, a default state), a centralized engineering team (e.g., with an independent organization resistance 610-c (R_{eng_c}^{organizational_ind})) may include reduced interactions within other teams included in the engineering organization (e.g., an engineering team m and an engineering team n). For example, in the state 605-a, a model circuit for the engineering organization may include independent organizational resistance 610-a of the engineering team m, independent organizational resistance 610-b of the engineering team n, inter-structure resistance 620-a between the engineering team m and the engineering team n, and inter-structure resistance 620-b between the engineering team n and the engineering team m. Additionally, or alternatively, the model circuit for the engineering organization in the state 605-a may exclude the independent organization resistance 610-c of the centralized engineering team.

In some examples, increased inter-team communication (e.g., between the centralized engineering team, the engineering team m, and the engineering team n) may occur if outputs become useful. For example, if outputs become useful, a technology point, a technology transfer, or a team transfer may occur. For a technology transfer (e.g., a transfer to a state 605-b), the centralized engineering team may work with the other engineering teams (e.g., the engineering team n and the engineering team m) to transfer outputs, such that the other engineering teams may use the output at a later time. During the technology transfer (e.g., to the state 605-b), an engineering structure resistance may increase. In some examples, however, the technology transfer may improve outcome current by either increasing outcome-output efficiency (e.g., in the case of adding novel technology components to make products suitable for customers), by improving organizational potential (e.g., in the case of upskilling engineering teams), or by reducing infrastructure resistance (e.g., in the case of improving the effectiveness of engineering infrastructure). For example, in the state 605-b, a model circuit may include the independent organizational resistance 610-a of the engineering team m, the independent organizational resistance 610-b of the engineering team n, the inter-structure resistance 620-a between the engineering team m and the engineering team n, the inter-structure resistance 620-b between the engineering team n and the engineering team m, the independent organization resistance 610-c of the centralized engineering team, inter-structure resistance 625-a between the centralized engineering team and the engineering team m, and the inter-structure resistance 625-b between the engineering team m and the centralized engineering team.

In some examples, subsequent to the technology transfer, the centralized engineering team may return to the state 605-a (e.g., the normal state, the default state). For example, the centralized engineering team may return to state 605-b with reduced inter-team communication with the engineering team m and the engineering team n. That is, the centralized engineering team may impose dynamic structure resistance on the engineering organization for a relatively short duration, which may lead to reduced structure resistance over time.

In a team transfer case (e.g., in a state 605-c, which may occur prior to transfer), the centralized engineering team may be in an incubation stage in which output may not contribute to the engineering output. In some examples, in response to a deliverable associated with the centralized engineering team maturing, the centralized engineering team may become an independent team contributing to the engineering output current. For example, in the state 605-c, a model circuit may include the independent organizational resistance 610-a of the engineering team m and the independent organizational resistance 610-b of the engineering team n, the inter-structure resistance 620-a between the engineering team m and the engineering team n and the inter-structure resistance 620-b between the engineering team n and the engineering team m, and the independent organization resistance 610-c of the centralized engineering team. In some examples, interactions and communication between teams may be dynamic. As such, an organization may evolve a structure of the organization to adapt to internal and external forces, such as organization and product directions, product lifecycles, market trends, and workforce diversity. As such, an engineering organizational circuit diagram may evolve over time.

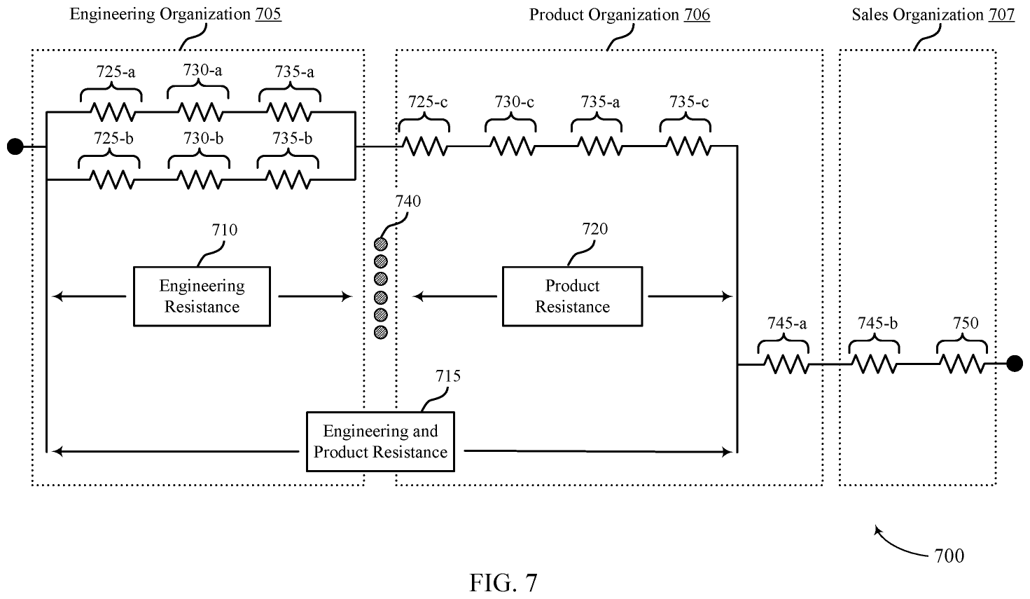

FIG. 7 illustrates an example of a model circuit 700 that supports techniques for measuring organizational productivity in accordance with aspects of the present disclosure. In some examples, the model circuit 700 may implement or be implemented at aspects of the system 100, the model circuit 200, the communication pathway 300, the model circuit 400, the model circuits 500, and the engineering team diagram 600. For example, the model circuit 700 may be implemented at a client device or a software platform, or both, which may be examples of the corresponding devices as described with reference to FIGS. 1 through 4, 5A, 5B, and 6. In some examples, an organization may use the software platform (e.g., via the client device) to generate the model circuit 700 for improved organizational productivity, among other possible benefits.

In some examples, an engineering organization may interact with other organizations to turn engineering outputs into desired company outcomes (e.g., revenue and profit). For example, to achieve a goal, engineering teams (e.g., an engineering organization 705) may work with product teams (e.g., a product organization 706) to identify desirable products for customers. Additionally, or alternatively, engineering teams may build, operate, maintain, and upgrade the products. As illustrated in the example of FIG. 7, the product organization 706 (e.g., a product team) may operate with dependent workstream teams working on independent workstreams 740. Additionally, or alternatively, the product organization 706 (e.g., a product and marketing organization) may work with a sales organization 707 to drive company outcome. In some examples, an organization-level organizational circuit diagram may include organizational resistors of an engineering team m and an engineering team n in parallel. That is, an engineering organization 705 may include the engineering team m and the engineering team n and, as such, may include an engineering resistance 710 that may be based on a resistance associated with the engineering team m and a resistance associated with the engineering team n.

For example, the engineering resistance 710 may include independent organizational resistance 725-a of the engineering team m (R_{eng_m}^{organizational_ind}), independent organizational resistance 725-b of the engineering team n (R_{eng_n}^{organizational_ind}), inter-structure resistance 730-a across dependent engineering teams that may impact workstreams associated with the engineering team m (Σᵢ^{dep eng teams}R_{eng_n,eng_i}^{structure}), and the inter-structure resistance 730-b across dependent engineering teams that may impact workstreams associated with the engineering team n (Σᵢ^{dep eng teams}R_{eng_n,eng_i}^{structure}). The organizational resistors associated with engineering team m and the engineering team n may be in series with the organizational resistors associated with a product team (e.g., the product organization 706) used by the engineering team m and the engineering team n. As such, the engineering resistance may include inter-structure resistance 735-a between the product organization 706 and the engineering team m (R_{eng_m,prod_m+n}^{structure}) and inter-structure resistance 735-b between the product organization 706 and the engineering team n (R_{eng_n,prod_m+n}^{structure}). The inter-structure resistance 735-a and the inter-structure resistance 735-b may describe collaborations at the product and engineering level. Additionally, or alternatively, product resistance 720 may include independent organizational resistance 725-c of the product organization 706 (R_{prod}_{ₘ}₊ₙ^{organizational_ind}), inter-structure resistance 730-c across dependent product teams that may impact workstreams associated with the product organization 706 (Σᵢ^{dep prod teams}R_{prod}_{ₘ}_{+n,prod_i}^{structure), the inter-structure resistance 735-}a between the product organization 706 and the engineering team m, and inter-structure resistance 735-c between and the engineering team m and the product organization 706.

In some examples, engineering and product resistance 715 (R_{eng+prod}^{organizational}) may include organizational resistance of the engineering organization 705 and the product organization 706 and may result from organizational resistors of the independent workstreams 740 being in parallel. Additionally, or alternatively, the engineering and product organizational resistor (e.g., representing the engineering and product resistance 715) may be connected in series with a sales organizational resistor. For example, the sales organization 707 may impose sales resistance 750 (Rₛₐₗₑₛ^{organizational}), inter-structure resistance 745-a between the product organization 706 and the sales organization 707 (R_{prod,sales}^{structure}), and inter-structure resistance 745-b between the sales organization 707 and the product organization 706 (R_{sales,prod}^{structure}) due to the product organization 706 working with the sales organization 707 (e.g., to achieve revenue and profit goals).

For some organizations, a reduced team structure may include engineers, product managers, and designers. For example, such a reduced team structure may encourage end-to-end workstream ownership and reduce organizational resistance. As such, the organizational resistance of the product organization 706 and the engineering organization 705 may converge to the organizational resistance of a product triad, for example without unnecessary inter-structure resistance. In some other organizational structures, multiple business units in a company may have respective engineering, product, and sales organizations as well as profit and loss responsibilities, which may promote end-to-end autonomy and ownership. For example, a business unit may form an equivalent circuit diagram and organizational resistors included in the equivalent circuit may be placed in parallel to form a complete company organizational circuit diagram. That is, a company organizational circuit diagram (e.g., the model circuit 700) may be generated from a business unit organizational circuit diagram. Company or business unit organizational circuit diagrams may include independent organizational resistance of engineering, product, and sales, as well as the inter-structure resistance between the organizations.

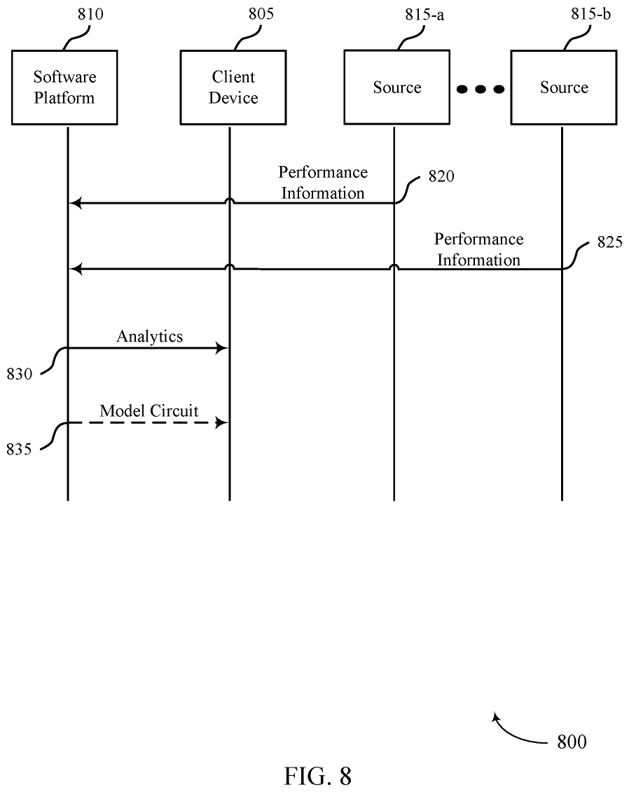

FIG. 8 illustrates an example of a process flow 800 that supports techniques for measuring organizational productivity in accordance with aspects of the present disclosure. In some examples, the process flow 800 may implement or be implemented at aspects of the system 100, the model circuit 200, and the communication pathway 300, the model circuit 400, the model circuits 500, the engineering team diagram 600, and the model circuit 700. For example, the process flow 800 may be implemented at a client device 805, a software platform 810, or both, which may be examples of the corresponding devices as described with reference to FIGS. 1 through 4, 5A, 5B, 6, and 7. The process flow 800 may also be implemented at one or more sources 815 (e.g., a source 815-a, a source 815-b). In the following description of the process flow 800, the information communicated between the client device 805, the software platform 810, and the sources 815 may be performed in different orders or at different times than shown. Additionally, or alternatively, some operations may be omitted from the process flow 800 and other operations may be added to the process flow 800. The process flow 800 may provide for improved management of organizational productivity, among other possible benefits. In some examples, the software platform 810 may be used to measure organizational productivity (e.g., organizational velocity). For example, the software platform 810 may be used to measure multiple types of organizational velocity, such as engineering velocity for engineering organizations and sales velocity sales organizations, among other examples.

In some examples, the software platform 810 may obtain performance information associated with an organization from multiple sources. For example, at 820, the software platform 810 may obtain performance information associated with the organization from a source 815-a. Additionally, at 825, the software platform may obtain performance information associated with the organization from the source 815-b. In some examples, the multiple sources may include internal operation data associated with the organization, customer data (e.g., usage data) associated with the organization, third-party data associated with the organization, or data obtained from a survey conducted at the organization. For example, the source 815-a may be an example of a syslog of one or more SaaS products (e.g., applications) associated with the organization from which the software platform may obtain customer data (e.g., via an API). Additionally, or alternatively, the source 815-b may be an example of a survey conducted at the organization. In some examples, the software platform 810 may obtain objective data associated with the organization from the source 815-a (e.g., a SaaS application) and subjective data associated with the organization from the source 815-b (e.g., a survey). In such an example, the performance information may include the objective data and the subjective data.

At 830, the software platform 810 may output analytics corresponding to a performance of the organization based on the performance information and one or more rules. The one or more rules may be based on a relationship between a rate of outcomes (e.g., outcome current), an output-outcome efficiency, an organizational potential, and an organizational resistance. For example, the one or more rules may be based on Organizational Ohm's Law. The analytics may be examples of analytics described throughout the present disclosure, including with reference to FIGS. 2 and 3. For example, the analytics may include an organizational output current metric based on organizational objective information and the one or more rules. In some examples, the organizational output current metric may be determined (e.g., measured) based on organizational goals, such as sales revenue, profit, revenue growth rate, profit margin, and ESG (Environmental, social, and corporate governance). For example, for determining an organizational output current metric associated with engineering velocity, the software platform 810 may use implied revenue from product features to represent engineering velocity. For example, the organization may build a product feature to sell software to customers (e.g., other organizations). As such, the product feature usage (e.g., adoption) may be used to measure success of the product feature.

In some examples, at 835, the software platform may output a model circuit representative of a structure of the organization. The model circuit may be an example of a model circuit as described throughout the present disclosure, including with reference to FIGS. 2, 4, 5A, 5B, and 7. For example, the model circuit may include multiple resistors and each resistor may corresponds to a respective organizational resistance metric. In some examples, outputting the model circuit at 835 may lead to increased organizational productivity, among other possible benefits.

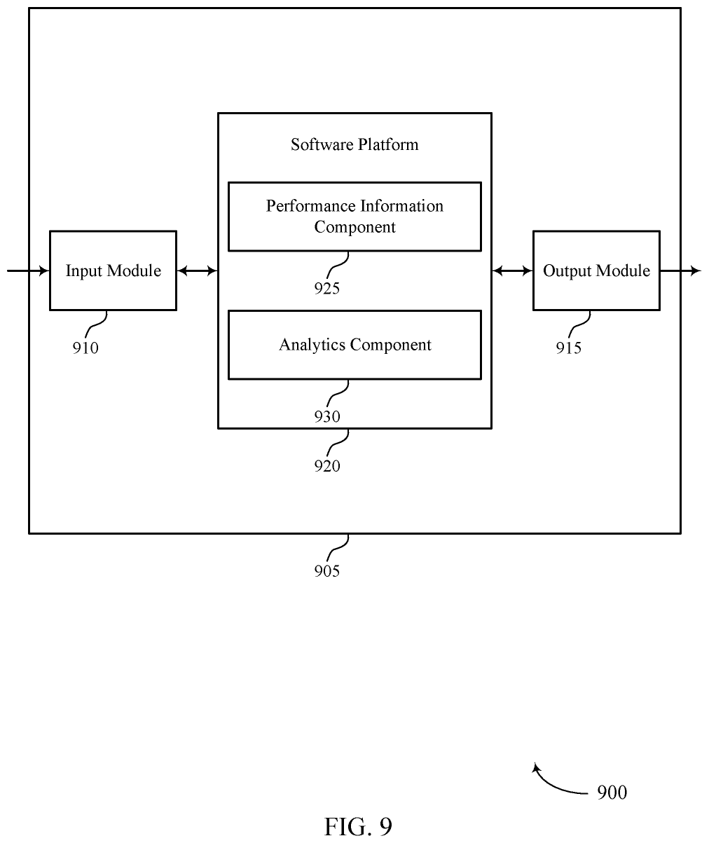

FIG. 9 illustrates a block diagram 900 of a device 905 that supports techniques for measuring organizational productivity in accordance with aspects of the present disclosure. The device 905 may include an input module 910, an output module 915, and a software platform 920. The device 905 may also include a processor. Each of these components may be in communication with one another (e.g., via one or more buses).

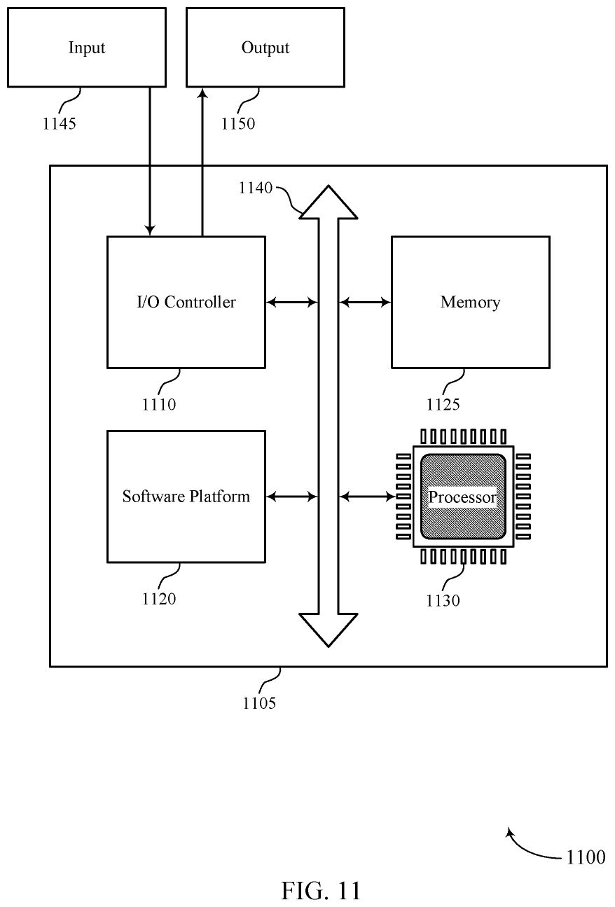

The input module 910 may manage input signals for the device 905. For example, the input module 910 may identify input signals based on an interaction with a modem, a keyboard, a mouse, a touchscreen, or a similar device. These input signals may be associated with user input or processing at other components or devices. In some cases, the input module 910 may utilize an operating system such as iOS®, ANDROID®, MS-DOS®, MS-WINDOWS®, OS/2®, UNIX®, LINUX®, or another known operating system to handle input signals. The input module 910 may send aspects of these input signals to other components of the device 905 for processing. For example, the input module 910 may transmit input signals to the software platform 920 to support techniques for measuring organizational productivity. In some cases, the input module 910 may be a component of an I/O controller 1110 as described with reference to FIG. 11.

The output module 915 may manage output signals for the device 905. For example, the output module 915 may receive signals from other components of the device 905, such as the software platform 920, and may transmit these signals to other components or devices. In some examples, the output module 915 may transmit output signals for display in a user interface, for storage in a database or data store, for further processing at a server or server cluster, or for any other processes at any number of devices or systems. In some cases, the output module 915 may be a component of an I/O controller 1110 as described with reference to FIG. 11.

For example, the software platform 920 may include a performance information component 925 an analytics component 930, or any combination thereof. In some examples, the software platform 920, or various components thereof, may be configured to perform various operations (e.g., receiving, monitoring, transmitting) using or otherwise in cooperation with the input module 910, the output module 915, or both. For example, the software platform 920 may receive information from the input module 910, send information to the output module 915, or be integrated in combination with the input module 910, the output module 915, or both to receive information, transmit information, or perform various other operations as described herein.

The software platform 920 may support managing organizational performance at a device (e.g., the device 905) in accordance with examples as disclosed herein. The performance information component 925 may be configured to support obtaining, at a software platform of the device, performance information associated with an organization from a set of multiple sources. The analytics component 930 may be configured to support outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

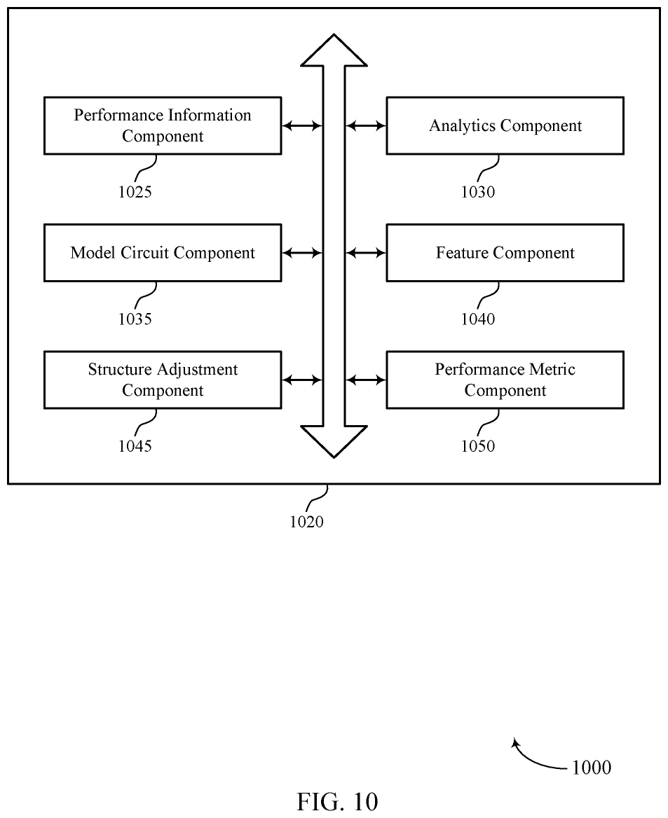

FIG. 10 illustrates a block diagram 1000 of a software platform 1020 that supports techniques for measuring organizational productivity in accordance with aspects of the present disclosure. The software platform 1020 may be an example of aspects of a software platform or a software platform 920, or both, as described herein. The software platform 1020, or various components thereof, may be an example of means for performing various aspects of techniques for measuring organizational productivity as described herein. For example, the software platform 1020 may include a performance information component 1025, an analytics component 1030, a model circuit component 1035, a feature component 1040, a structure adjustment component 1045, a performance metric component 1050, or any combination thereof. Each of these components may communicate, directly or indirectly, with one another (e.g., via one or more buses).

The software platform 1020 may support managing organizational performance at a device in accordance with examples as disclosed herein. The performance information component 1025 may be configured to support obtaining, at a software platform of the device, performance information associated with an organization from a set of multiple sources. The analytics component 1030 may be configured to support outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

In some examples, to support obtaining the performance information, the performance information component 1025 may be configured to support obtaining objective data associated with the organization from a first source of the set of multiple sources and subjective data associated with the organization from a second source of the set of multiple sources, where the performance information includes the objective data and the subjective data. In some examples, the first source includes a syslog of one or more SaaS products associated with the organization and the second source includes a survey conducted at the organization.

In some examples, to support obtaining the performance information, the performance information component 1025 may be configured to support obtaining the performance information associated with an organization from internal operation data associated with the organization, customer data associated with the organization, third-party data associated with the organization, or data obtained from a survey conducted at the organization, or any combination thereof.

In some examples, to support outputting the analytics, the analytics component 1030 may be configured to support outputting an organizational output current metric based on organizational objective information and the one or more rules, where the performance information includes the organizational objective information, and where the analytics include the organizational output current metric. In some examples, the organizational objective information corresponds to sales revenue, profit revenue, revenue growth rate, profit margin, and environmental, social, and corporate governance, or any combination thereof.

In some examples, to support outputting the analytics, the analytics component 1030 may be configured to support outputting an organizational outcome efficiency metric based on organizational outcome information and the one or more rules, where the performance information includes the organizational outcome information, and where the analytics include the organizational outcome efficiency metric. In some examples, the organizational outcome information corresponds to a respective customer satisfaction score associated with each feature of a set of multiple features developed at the organization.

In some examples, to support outputting the analytics, the analytics component 1030 may be configured to support outputting a set of multiple organizational resistance metrics based on organizational resistance information and the one or more rules, where the performance information includes the organizational resistance information, and where the analytics include the set of multiple organizational resistance metrics.

In some examples, the organizational resistance information corresponds to a distribution of a set of multiple durations during which one or more employees of the organization perform a set of multiple tasks. In some examples, each duration of the set of multiple durations corresponds to a respective task of the set of multiple tasks.

In some examples, the model circuit component 1035 may be configured to support outputting a model of a circuit representative of a structure of the organization, where the circuit includes a set of multiple resistors, and where each resistor of the set of multiple resistors corresponds to a respective organizational resistance metric of the set of multiple organizational resistance metrics.

In some examples, the performance information component 1025 may be configured to support outputting a first value of an organizational performance metric based on the circuit. In some examples, the structure adjustment component 1045 may be configured to support obtaining an adjustment associated with the structure of the organization based on the first value of the organizational performance metric. In some examples, the performance metric component 1050 may be configured to support obtaining a second value of the organizational performance metric based on the adjustment, the second value is different from the first value. In some examples, the organizational performance metric includes an organizational productivity metric or an organizational efficiency metric.

In some examples, to support outputting the analytics, the analytics component 1030 may be configured to support outputting an organizational potential metric based on organizational potential information and the one or more rules, where the performance information includes the organizational potential information, and where the analytics include the organizational potential metric. In some examples, the organizational potential information corresponds to a respective skill and a respective motivation associated with each employee of one or more employees of the organization. In some examples, the performance information includes historical information collected over a duration. In some examples, the analytics are based on the historical information.

In some examples, the analytics component 1030 may be configured to support outputting a set of analytics corresponding to the performance of the organization, where the set of analytics is associated with a set of multiple features provided by a software application associated with the organization, and where the performance information includes respective performance information associated with each feature of the set of multiple features. In some examples, the feature component 1040 may be configured to support selecting a feature of the set of multiple features based on the set of analytics.

FIG. 11 illustrates a diagram of a system 1100 including a device 1105 that supports techniques for measuring organizational productivity in accordance with aspects of the present disclosure. The device 1105 may be an example of or include the components of a device 905 as described herein. The device 1105 may include components for bi-directional data communications including components for transmitting and receiving communications, such as a software platform 1120, an I/O controller 1110, a memory 1125, and a processor 1130. These components may be in electronic communication or otherwise coupled (e.g., operatively, communicatively, functionally, electronically, electrically) via one or more buses (e.g., a bus 1140).

The I/O controller 1110 may manage input signals 1145 and output signals 1150 for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. In other cases, the I/O controller 1110 may represent or interact with a modem, a keyboard, a mouse, a touchscreen, or a similar device. In some cases, the I/O controller 1110 may be implemented as part of a processor 1130. In some examples, a user may interact with the device 1105 via the I/O controller 1110 or via hardware components controlled by the I/O controller 1110.

Memory 1125 may include random-access memory (RAM) and ROM. The memory 1125 may store computer-readable, computer-executable software including instructions that, when executed, cause the processor 1130 to perform various functions described herein. In some cases, the memory 1125 may contain, among other things, a BIOS which may control basic hardware or software operation such as the interaction with peripheral components or devices.

The processor 1130 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1130 may be configured to operate a memory array using a memory controller. In other cases, a memory controller may be integrated into the processor 1130. The processor 1130 may be configured to execute computer-readable instructions stored in a memory 1125 to perform various functions (e.g., functions or tasks supporting techniques for measuring organizational productivity).

The software platform 1120 may support managing organizational performance at a device (e.g., the device 1105) in accordance with examples as disclosed herein. For example, the software platform 1120 may be configured to support obtaining, at a software platform of the device, performance information associated with an organization from a set of multiple sources. The software platform 1120 may be configured to support outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

By including or configuring the software platform 1120 in accordance with examples as described herein, the device 1105 may support techniques for more efficient utilization of communication resources.

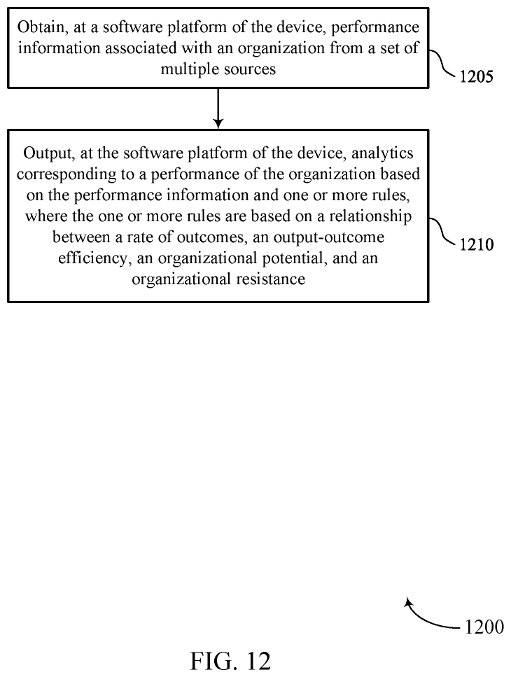

FIG. 12 illustrates a flowchart showing a method 1200 that supports techniques for measuring organizational productivity in accordance with aspects of the present disclosure. The operations of the method 1200 may be implemented by a device or its components as described herein. For example, the operations of the method 1200 may be performed by a device as described with reference to FIGS. 1 through 11. In some examples, a device may execute a set of instructions to control the functional elements of the device to perform the described functions. Additionally, or alternatively, the device may perform aspects of the described functions using special-purpose hardware.

At 1205, the method may include obtaining, at a software platform of the device, performance information associated with an organization from a set of multiple sources. The operations of 1205 may be performed in accordance with examples as disclosed herein. In some examples, aspects of the operations of 1205 may be performed by a performance information component 1025 as described with reference to FIG. 10.

At 1210, the method may include outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance. The operations of 1210 may be performed in accordance with examples as disclosed herein. In some examples, aspects of the operations of 1210 may be performed by an analytics component 1030 as described with reference to FIG. 10.

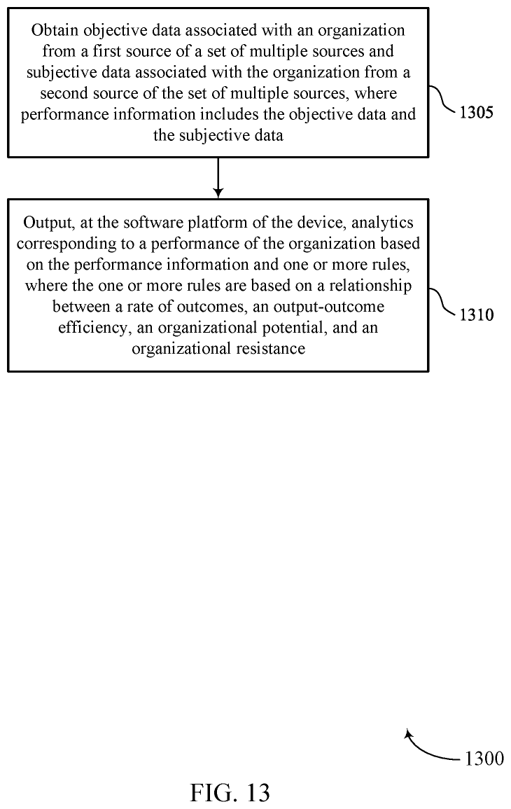

FIG. 13 illustrates a flowchart showing a method 1300 that supports techniques for measuring organizational productivity in accordance with aspects of the present disclosure. The operations of the method 1300 may be implemented by a device or its components as described herein. For example, the operations of the method 1300 may be performed by a device as described with reference to FIGS. 1 through 11. In some examples, a device may execute a set of instructions to control the functional elements of the device to perform the described functions. Additionally, or alternatively, the device may perform aspects of the described functions using special-purpose hardware.

At 1305, the method may include obtaining, at a software platform of the device, objective data associated with the organization from a first source of a set of multiple sources and subjective data associated with the organization from a second source of the set of multiple sources, where performance information includes the objective data and the subjective data. The operations of 1305 may be performed in accordance with examples as disclosed herein. In some examples, aspects of the operations of 1305 may be performed by a performance information component 1025 as described with reference to FIG. 10.

At 1310, the method may include outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance. The operations of 1310 may be performed in accordance with examples as disclosed herein. In some examples, aspects of the operations of 1310 may be performed by an analytics component 1030 as described with reference to FIG. 10.

A method for managing organizational performance at a device is described. The method may include obtaining, at a software platform of the device, performance information associated with an organization from a set of multiple sources and outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

An apparatus for managing organizational performance at a device is described. The apparatus may include a processor, memory coupled with the processor, and instructions stored in the memory. The instructions may be executable by the processor to cause the apparatus to obtain, at a software platform of the device, performance information associated with an organization from a set of multiple sources and output, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

Another apparatus for managing organizational performance at a device is described. The apparatus may include means for obtaining, at a software platform of the device, performance information associated with an organization from a set of multiple sources and means for outputting, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

A non-transitory computer-readable medium storing code for managing organizational performance at a device is described. The code may include instructions executable by a processor to obtain, at a software platform of the device, performance information associated with an organization from a set of multiple sources and output, at the software platform of the device, analytics corresponding to a performance of the organization based on the performance information and one or more rules, where the one or more rules are based on a relationship between a rate of outcomes, an output-outcome efficiency, an organizational potential, and an organizational resistance.

In some examples of the method, apparatuses, and non-transitory computer-readable medium described herein, obtaining the performance information may include operations, features, means, or instructions for obtaining objective data associated with the organization from a first source of the set of multiple sources and subjective data associated with the organization from a second source of the set of multiple sources, where the performance information includes the objective data and the subjective data.

In some examples of the method, apparatuses, and non-transitory computer-readable medium described herein, the first source includes a system log of one or more software-as-a-service products associated with the organization and the second source includes a survey conducted at the organization.

In some examples of the method, apparatuses, and non-transitory computer-readable medium described herein, obtaining the performance information may include operations, features, means, or instructions for obtaining the performance information associated with an organization from internal operation data associated with the organization, customer data associated with the organization, third-party data associated with the organization, or data obtained from a survey conducted at the organization, or any combination thereof.

In some examples of the method, apparatuses, and non-transitory computer-readable medium described herein, outputting the analytics may include operations, features, means, or instructions for outputting an organizational output current metric based on organizational objective information and the one or more rules, where the performance information includes the organizational objective information, and where the analytics include the organizational output current metric.

In some examples of the method, apparatuses, and non-transitory computer-readable medium described herein, the organizational objective information corresponds to sales revenue, profit revenue, revenue growth rate, profit margin, and environmental, social, and corporate governance, or any combination thereof.

In some examples of the method, apparatuses, and non-transitory computer-readable medium described herein, outputting the analytics may include operations, features, means, or instructions for outputting an organizational outcome efficiency metric based on organizational outcome information and the one or more rules, where the performance information includes the organizational outcome information, and where the analytics include the organizational outcome efficiency metric.

In some examples of the method, apparatuses, and non-transitory computer-readable medium described herein, the organizational outcome information corresponds to a respective customer satisfaction score associated with each feature of a set of multiple features developed at the organization.

In some examples of the method, apparatuses, and non-transitory computer-readable medium described herein, outputting the analytics may include operations, features, means, or instructions for outputting a set of multiple organizational resistance metrics based on organizational resistance information and the one or more rules, where the performance information includes the organizational resistance information, and where the analytics include the set of multiple organizational resistance metrics.

In some examples of the method, apparatuses, and non-transitory computer-readable medium described herein, the organizational resistance information corresponds to a distribution of a set of multiple durations during which one or more employees of the organization perform a set of multiple tasks and each duration of the set of multiple durations corresponds to a respective task of the set of multiple tasks.

Some examples of the method, apparatuses, and non-transitory computer-readable medium described herein may further include operations, features, means, or instructions for outputting a model of a circuit representative of a structure of the organization, where the circuit includes a set of multiple resistors, and where each resistor of the set of multiple resistors corresponds to a respective organizational resistance metric of the set of multiple organizational resistance metrics.

Some examples of the method, apparatuses, and non-transitory computer-readable medium described herein may further include operations, features, means, or instructions for outputting a first value of an organizational performance metric based on the circuit, obtaining an adjustment associated with the structure of the organization based on the first value of the organizational performance metric, and obtaining a second value of the organizational performance metric based on the adjustment, the second value may be different from the first value.

In some examples of the method, apparatuses, and non-transitory computer-readable medium described herein, the organizational performance metric includes an organizational productivity metric or an organizational efficiency metric.

In some examples of the method, apparatuses, and non-transitory computer-readable medium described herein, outputting the analytics may include operations, features, means, or instructions for outputting an organizational potential metric based on organizational potential information and the one or more rules, where the performance information includes the organizational potential information, and where the analytics include the organizational potential metric.

In some examples of the method, apparatuses, and non-transitory computer-readable medium described herein, the organizational potential information corresponds to a respective skill and a respective motivation associated with each employee of one or more employees of the organization.

In some examples of the method, apparatuses, and non-transitory computer-readable medium described herein, the performance information includes historical information collected over a duration and the analytics may be based on the historical information.

Some examples of the method, apparatuses, and non-transitory computer-readable medium described herein may further include operations, features, means, or instructions for outputting a set of analytics corresponding to the performance of the organization, where the set of analytics may be associated with a set of multiple features provided by a software application associated with the organization, and where the performance information includes respective performance information associated with each feature of the set of multiple features.

Some examples of the method, apparatuses, and non-transitory computer-readable medium described herein may further include operations, features, means, or instructions for selecting a feature of the set of multiple features based on the set of analytics.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing organizational performance at a device, comprising:
obtaining, at a software platform of the device, performance information associated with an organization from a plurality of sources; and
outputting, at the software platform of the device, analytics corresponding to a performance of the organization based at least in part on the performance information and one or more rules, wherein the one or more rules are based at least in part on a relationship between a rate of outcomes, an output-outcome efficiency, an organizational potential, and an organizational resistance.

2. The method of claim 1, wherein obtaining the performance information comprises:
obtaining objective data associated with the organization from a first source of the plurality of sources and subjective data associated with the organization from a second source of the plurality of sources, wherein the performance information comprises the objective data and the subjective data.

3. The method of claim 2, wherein the first source includes a system log of one or more software-as-a-service products associated with the organization and the second source includes a survey conducted at the organization.

4. The method of claim 1, wherein obtaining the performance information comprises:
obtaining the performance information associated with an organization from internal operation data associated with the organization, customer data associated with the organization, third-party data associated with the organization, or data obtained from a survey conducted at the organization, or any combination thereof.

5. The method of claim 1, wherein outputting the analytics comprises:
outputting an organizational output current metric based at least in part on organizational objective information and the one or more rules, wherein the performance information comprises the organizational objective information, and wherein the analytics comprise the organizational output current metric.

6. The method of claim 5, wherein the organizational objective information corresponds to sales revenue, profit revenue, revenue growth rate, profit margin, and environmental, social, and corporate governance, or any combination thereof.

7. The method of claim 1, wherein outputting the analytics comprises:
outputting an organizational outcome efficiency metric based at least in part on organizational outcome information and the one or more rules, wherein the performance information comprises the organizational outcome information, and wherein the analytics comprise the organizational outcome efficiency metric.

8. The method of claim 7, wherein the organizational outcome information corresponds to a respective customer satisfaction score associated with each feature of a plurality of features developed at the organization.

9. The method of claim 1, wherein outputting the analytics comprises:
outputting a plurality of organizational resistance metrics based at least in part on organizational resistance information and the one or more rules, wherein the performance information comprises the organizational resistance information, and wherein the analytics comprise the plurality of organizational resistance metrics.

10. The method of claim 9, wherein the organizational resistance information corresponds to a distribution of a plurality of durations during which one or more employees of the organization perform a plurality of tasks, each duration of the plurality of durations corresponds to a respective task of the plurality of tasks.

11. The method of claim 9, further comprising:
outputting a model of a circuit representative of a structure of the organization, wherein the circuit comprises a plurality of resistors, and wherein each resistor of the plurality of resistors corresponds to a respective organizational resistance metric of the plurality of organizational resistance metrics.

12. The method of claim 11, further comprising:
outputting a first value of an organizational performance metric based at least in part on the circuit;
obtaining an adjustment associated with the structure of the organization based at least in part on the first value of the organizational performance metric; and
obtaining a second value of the organizational performance metric based at least in part on the adjustment, the second value is different from the first value.

13. The method of claim 12, wherein the organizational performance metric comprises an organizational productivity metric or an organizational efficiency metric.

14. The method of claim 1, wherein outputting the analytics comprises:
outputting an organizational potential metric based at least in part on organizational potential information and the one or more rules, wherein the performance information comprises the organizational potential information, and wherein the analytics comprise the organizational potential metric.

15. The method of claim 14, wherein the organizational potential information corresponds to a respective skill and a respective motivation associated with each employee of one or more employees of the organization.

16. The method of claim 1, wherein the performance information comprises historical information collected over a duration, and the analytics are based at least in part on the historical information.

17. The method of claim 1, further comprising:
outputting a set of analytics corresponding to the performance of the organization, wherein the set of analytics is associated with a plurality of features provided by a software application associated with the organization, and wherein the performance information comprises respective performance information associated with each feature of the plurality of features.

18. The method of claim 17, further comprising:
selecting a feature of the plurality of features based at least in part on the set of analytics.

19. An apparatus for managing organizational performance at a device, comprising:
a processor;
memory coupled with the processor; and
instructions stored in the memory and executable by the processor to cause the apparatus to:
obtain, at a software platform of the device, performance information associated with an organization from a plurality of sources; and
output, at the software platform of the device, analytics corresponding to a performance of the organization based at least in part on the performance information and one or more rules, wherein the one or more rules are based at least in part on a relationship between a rate of outcomes, an output-outcome efficiency, an organizational potential, and an organizational resistance.

20. A non-transitory computer-readable medium storing code for managing organizational performance at a device, the code comprising instructions executable by a processor to:
obtain, at a software platform of the device, performance information associated with an organization from a plurality of sources; and
output, at the software platform of the device, analytics corresponding to a performance of the organization based at least in part on the performance information and one or more rules, wherein the one or more rules are based at least in part on a relationship between a rate of outcomes, an output-outcome efficiency, an organizational potential, and an organizational resistance.
